(19) United States
(12) Patent Application Publication
(10) Pub. No.: US 2025/0045251 A1
(43) Pub. Date: Feb. 6, 2025

(54) MACHINE LEARNING OPITIMIZATION SYSTEM FOR CODEBOOK REFINEMENT IN INTRACHIP COMMUNICATIONS

(71) Applicant: AtomBeam Technologies Inc., Moraga, CA (US)

(72) Inventors: Joshua Cooper, Columbia, SC (US); Charles Yeomans, Orinda, CA (US); Gregory Caltabiano, Palo Alto, CA (US)

(21) Appl. No.: 18/919,459

(22) Filed: Oct. 18, 2024

Related U.S. Application Data
(63) Continuation-in-part of application No. 18/480,497, filed on Oct. 3, 2023.
Application No. 18/480,497 is a continuation of application No. 17/234,007, filed on Apr. 19, 2021, now Pat. No. 11,782,879.
Application No. 17/234,007 is a continuation-in-part of application No. 17/180,439, filed on Feb. 19, 2021, now Pat. No. 11,366,790.
Application No. 17/180,439 is a continuation-in-part of application No. 16/923,039, filed on Jul. 7, 2020, now Pat. No. 11,232,076.
Application No. 16/923,039 is a continuation-in-part of application No. 16/716,098, filed on Dec. 16, 2019, now Pat. No. 10,706,018.
Application No. 16/716,098 is a continuation of application No. 16/455,655, filed on Jun. 27, 2019, now Pat. No. 10,509,771.
Application No. 16/455,655 is a continuation-in-part of application No. 16/200,466, filed on Nov. 26, 2018, now Pat. No. 10,476,519.
Application No. 16/200,466 is a continuation-in-part of application No. 15/975,741, filed on May 9, 2018, now Pat. No. 10,303,391.
(60) Provisional application No. 63/140,111, filed on Jan. 21, 2021.
(60) Provisional application No. 63/027,166, filed on May 19, 2020.
(60) Provisional application No. 62/578,824, filed on Oct. 30, 2017.
(60) Provisional application No. 62/926,723, filed on Oct. 28, 2019.

(51) Int. Cl. G06F 16/174; G06F 3/06

(52) U.S. Cl. CPC G06F 16/1752; G06F 3/0608; G06F 3/0641; G06F 3/067

(57) ABSTRACT

A system and method for optimizing intrachip communication using machine learning-based codebook refinement is presented. The system employs an on-chip machine learning model to continuously analyze data patterns and update a codebook used for data compression in intrachip communication. Key aspects may comprise real-time data collection, feature extraction, performance monitoring, and gradual codebook updates. The system adapts to evolving data patterns, improving compression efficiency over time. A fallback mechanism ensures system stability by reverting to a conservative codebook if performance degrades. Security measures, including cryptographic signatures for updates and anomaly detection, are integrated. The system optimizes power consumption by adjusting operations based on the chip's power state. This adaptive approach significantly enhances intrachip communication efficiency, potentially improving overall chip performance and energy efficiency. The system's design allows for efficient execution within the constraints of on-chip resources, making it suitable for implementation in various multi-core processor architectures.

### CROSS-REFERENCE TO RELATED APPLICATIONS

Priority is claimed in the application data sheet to the following patents or patent applications, each of which is expressly incorporated herein by reference in its entirety:
Ser. No. 18/480,497
Ser. No. 17/234,007
Ser. No. 17/180,439
63/140,111
Ser. No. 16/923,039
63/027,166
Ser. No. 16/716,098
Ser. No. 16/455,655
Ser. No. 16/200,466
Ser. No. 15/975,741
62/578,824
62/926,723

### BACKGROUND OF THE INVENTION

### Field of the Invention

The present invention is in the field of integrated circuit design and intrachip communication, and more particularly focuses on adaptive codebook refinement for improving the efficiency of data encoding and decoding in high-speed intrachip communications.

### Discussion of the State of the Art

In modern computing systems, the efficiency of intrachip communication plays an important role in overall system performance. As the complexity and scale of integrated circuits continue to grow, with multiple cores and specialized processing units being incorporated onto a single chip, the demand for high-speed, low-latency data transfer between these components has intensified. Traditional approaches to intrachip communication have relied on fixed-width buses and standard protocols, which, while functional, often fail to fully optimize the bandwidth utilization and power consumption of the system.

One of the key strategies used to improve intrachip communication efficiency is data compression. By reducing the amount of data that needs to be transmitted between different parts of a chip, compression techniques can effectively increase the available bandwidth and reduce power consumption. The current state of the art in this domain primarily involves static compression schemes, such as Huffman coding or run-length encoding, which use predefined codebooks to map frequently occurring data patterns to shorter codewords. These static codebooks are typically generated based on statistical analysis of expected data patterns and are hardcoded into the chip's firmware during manufacturing.

While static compression schemes have proven effective to some degree, they suffer from several limitations. Firstly, they lack adaptability to changing data patterns over time. The initial statistical analysis used to generate the codebook may not accurately reflect the actual data patterns encountered during the chip's operation, especially as the chip is used for different applications or as usage patterns evolve. This mismatch can lead to suboptimal compression ratios and reduced efficiency in data transfer. Secondly, static codebooks cannot take advantage of temporal or contextual patterns that may emerge during the chip's operation, missing opportunities for further optimization. Lastly, the one-size-fits-all approach of static codebooks fails to account for variations in data patterns across different parts of the chip or different operational modes, potentially leading to inefficiencies in specific scenarios.

Another limitation of current intrachip communication systems is their inability to learn and improve from actual usage data. While post-deployment analysis might be used to refine codebooks for future chip designs, existing chips cannot benefit from this knowledge, remaining constrained by their initial configuration. This lack of adaptability not only limits the potential for ongoing performance improvements but also reduces the chip's ability to optimize for specific workloads or applications.

Furthermore, the increasing concern over power consumption in modern computing systems highlights another shortcoming of current approaches. Static compression schemes, while somewhat effective at reducing data transfer volume, do not dynamically optimize for power efficiency based on changing operational conditions or power states of the chip. This inflexibility can result in missed opportunities for energy savings, particularly in scenarios where power conservation is critical, such as in mobile or battery-powered devices.

What is needed is a machine learning optimization system for codebook refinement in intrachip communications which addresses these limitations by introducing an adaptive, learning-based approach to data compression and transfer. By employing on-chip machine learning algorithms, the system can continuously analyze data patterns, update the codebook, and improve compression efficiency over time. This dynamic approach allows the system to adapt to changing data patterns, whether they result from different applications, evolving usage patterns, or variations across different parts of the chip.

The optimization system's ability to learn from actual usage data enables it to discover and exploit patterns that may not have been apparent in initial statistical analyses. This can lead to significantly improved compression ratios and more efficient bandwidth utilization. Moreover, the system's adaptability allows it to optimize for different operational modes or power states, potentially offering substantial improvements in energy efficiency.

### SUMMARY OF THE INVENTION

Accordingly, the inventor has disclosed, a system and method for optimizing intrachip communication using machine learning-based codebook refinement is presented. The system employs an on-chip machine learning model to continuously analyze data patterns and update a codebook used for data compression in intrachip communication. Key features include real-time data collection, feature extraction, performance monitoring, and gradual codebook updates. The system adapts to evolving data patterns, improving compression efficiency over time. A fallback mechanism ensures system stability by reverting to a conservative codebook if performance degrades. Security measures, including cryptographic signatures for updates and anomaly detection, are integrated. The system optimizes power consumption by adjusting operations based on the chip's power state. This adaptive approach significantly enhances intrachip communication efficiency, potentially improving overall chip performance and energy efficiency. The system's design allows for efficient execution within the constraints of on-chip resources, making it suitable for implementation in various multi-core processor architectures.

According to a preferred embodiment, a system for optimizing intrachip communication using machine learning is disclosed, comprising: a computing device comprising at least a memory and a processor; a plurality of programming instructions stored in the memory and operable on the processor, wherein the plurality of programming instructions, when operating on the processor, cause the computing device to: collect data on codebook usage during intrachip communication; extract features from the collected data; analyze the extracted features using a machine learning model to recommend codebook updates; implement the recommended updates to the codebook; monitor performance metrics to evaluate the effectiveness of the updates; and adjust the codebook refinement process based on the monitored performance metrics.

According to another preferred embodiment, a method for optimizing intrachip communication using machine learning is disclosed, comprising the steps of: collecting data on codebook usage during intrachip communication; extracting features from the collected data; analyzing the extracted features using a machine learning model to recommend codebook updates; implementing the recommended updates to the codebook; monitoring performance metrics to evaluate the effectiveness of the updates; and adjusting the codebook refinement process based on the monitored performance metrics.

According to an aspect of an embodiment, the data collection is performed continuously during intrachip communication.

According to an aspect of an embodiment, the features extracted from the collected data include frequency of codeword usage, patterns of unmatched sourceblocks, and temporal patterns of data transmission.

According to an aspect of an embodiment, the machine learning model is designed for efficient execution within the constraints of on-chip resources.

According to an aspect of an embodiment, the implementation of recommended updates to the codebook occurs in real-time, thereby adapting the codebook to evolving data patterns.

According to an aspect of an embodiment, the monitored performance metrics include compression ratio, encoding/decoding speed, and frequency of codebook misses.

According to an aspect of an embodiment, the plurality of programming instructions further cause the computing device to maintain system stability by implementing gradual updates to the codebook, wherein the rate of change is dynamically adjusted based on the monitored performance metrics.

According to an aspect of an embodiment, the plurality of programming instructions further cause the computing device to provide a fallback mechanism to a pre-trained, conservative codebook during initial operation or if performance falls below a threshold.

According to an aspect of an embodiment, the plurality of programming instructions further cause the computing device to implement a secure update mechanism using cryptographic signatures to prevent unauthorized codebook modifications.

According to an aspect of an embodiment, the plurality of programming instructions further cause the computing device to optimize power consumption by adjusting the codebook refinement process based on the current power state of the chip.

According to an aspect of an embodiment, the machine learning model is incrementally trained using the collected data, allowing for ongoing adaptation to changing data patterns without the need for offline retraining.

According to an aspect of an embodiment, the plurality of programming instructions further cause the computing device to implement a multi-level codebook system, wherein different codebooks are optimized for different types of data or different parts of the chip, and are selected dynamically based on the current communication context.

According to an aspect of an embodiment, the plurality of programming instructions further cause the computing device to use synthetic data generation techniques to augment training data during initial system operation.

According to an aspect of an embodiment, the plurality of programming instructions further cause the computing device to implement an anomaly detection mechanism to identify potential security threats based on unusual patterns in codebook usage or update requests.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram showing an embodiment of the system in which all components of the system are operated locally.

FIG. 2 is a diagram showing an embodiment of one aspect of the system, the data deconstruction engine.

FIG. 3 is a diagram showing an embodiment of one aspect of the system, the data reconstruction engine.

FIG. 4 is a diagram showing an embodiment of one aspect of the system, the library management module.

FIG. 5 is a diagram showing another embodiment of the system in which data is transferred between remote locations.

FIG. 6 is a diagram showing an embodiment in which a standardized version of the sourceblock library and associated algorithms would be encoded as firmware on a dedicated processing chip included as part of the hardware of a plurality of devices.

FIG. 7 is a diagram showing an example of how data might be converted into reference codes using an aspect of an embodiment.

FIG. 8 is a method diagram showing the steps involved in using an embodiment to store data.

FIG. 9 is a method diagram showing the steps involved in using an embodiment to retrieve data.

FIG. 10 is a method diagram showing the steps involved in using an embodiment to encode data.

FIG. 11 is a method diagram showing the steps involved in using an embodiment to decode data.

FIG. 12 is a diagram showing an exemplary system architecture, according to a preferred embodiment of the invention.

FIG. 13 is a diagram showing a more detailed architecture for a customized library generator.

FIG. 14 is a diagram showing a more detailed architecture for a library optimizer.

FIG. 15 is a diagram showing a more detailed architecture for a transmission and storage engine.

FIG. 16 is a method diagram illustrating key system functionality utilizing an encoder and decoder pair.

FIG. 17 is a method diagram illustrating possible use of a hybrid encoder/decoder to improve the compression ratio.

FIG. 18 is a flow diagram illustrating the use of a data encoding system used to recursively encode data to further reduce data size.

FIG. 19 is an exemplary system architecture of a data encoding system used for cyber security purposes.

FIG. 20 is a flow diagram of an exemplary method used to detect anomalies in received encoded data and producing a warning.

FIG. 21 is a flow diagram of a data encoding system used for Distributed Denial of Service (DDOS) attack denial.

FIG. 22 is an exemplary system architecture of a data encoding system used for data mining and analysis purposes.

FIG. 23 is a flow diagram of an exemplary method used to enable high-speed data mining of repetitive data.

FIG. 24 is an exemplary system architecture of a data encoding system used for remote software and firmware updates.

FIG. 25 is a flow diagram of an exemplary method used to encode and transfer software and firmware updates to a device for installation, for the purposes of reduced bandwidth consumption.

FIG. 26 is an exemplary system architecture of a data encoding system used for large-scale software installation such as operating systems.

FIG. 27 is a flow diagram of an exemplary method used to encode new software and operating system installations for reduced bandwidth required for transference.

FIG. 28 is a diagram showing an embodiment in which a pre-trained version of the codebook library and associated algorithms would be encoded as firmware on an exemplary multi-core processing chip included as part of the hardware of a plurality of devices.

FIG. 29 is a diagram showing an embodiment in which a pre-trained version of the codebook library and associated algorithms would be encoded as firmware on an exemplary multi-chip module included as part of the hardware of a plurality of devices.

FIG. 30 is a diagram showing an embodiment in which a pre-trained version of the codebook library and associated algorithms would be encoded as firmware on an exemplary server motherboard operating within a server rack.

FIG. 31 is a flow diagram of an exemplary method used to transmit encoded data between one or more processing cores of a multi-core processing chip for increased bandwidth required for transmittance.

FIG. 32 is a diagram showing an exemplary embodiment in which a pre-trained version of the codebook library, associated algorithms, and a codebook optimization system are encoded as firmware on a semiconductor multi-core processing chip included as part of the hardware of a plurality of devices.

FIG. 33 is a block diagram illustrating an exemplary aspect of a component of a dynamic codebook refinement and optimization system, a machine learning optimization system.

FIG. 34 is a flow diagram illustrating an exemplary method for optimizing codebook refinement in intrachip communications, according to an embodiment

FIG. 35 is a flow diagram illustrating an exemplary method for implementing a fallback mechanism, according to an embodiment.

FIG. 36 illustrates an exemplary computing environment on which an embodiment described herein may be implemented.

### DETAILED DESCRIPTION OF THE INVENTION

The inventor has conceived, and reduced to practice, a system and method for optimizing intrachip communication using machine learning-based codebook refinement is presented. The system employs an on-chip machine learning model to continuously analyze data patterns and update a codebook used for data compression in intrachip communication. Key features include real-time data collection, feature extraction, performance monitoring, and gradual codebook updates. The system adapts to evolving data patterns, improving compression efficiency over time. A fallback mechanism ensures system stability by reverting to a conservative codebook if performance degrades. Security measures, including cryptographic signatures for updates and anomaly detection, are integrated. The system optimizes power consumption by adjusting operations based on the chip's power state. This adaptive approach significantly enhances intrachip communication efficiency, potentially improving overall chip performance and energy efficiency. The system's design allows for efficient execution within the constraints of on-chip resources, making it suitable for implementation in various multi-core processor architectures.

By implementing the machine learning algorithms directly on the chip, the system can provide real-time optimization without the need for external analysis or updates. This on-chip learning approach also ensures that the system can maintain data privacy and security, as sensitive information doesn't need to leave the chip for analysis.

The proposed system also addresses the challenge of initial performance through the use of pre-trained models and conservative initial codebooks. This approach ensures that the system performs at least as well as traditional static methods from the outset, while providing the potential for significant improvements over time as it learns from actual usage patterns.

According to an embodiment, implementing different codebooks or encoding strategies based on the chip's power state can optimize energy consumption, particularly important in battery-powered or energy-efficient devices. This feature may be realized by creating multiple codebooks optimized for different power states and integrating them into the existing firmware. The system can monitor the chip's current power state (e.g., full performance, low power, or sleep mode) and switch between codebooks accordingly. In low power states, the system might use a simpler codebook with shorter codewords but lower compression ratios, trading some efficiency for reduced processing overhead. For example, when a mobile device enters a battery-saving mode, the chip could switch to a power-optimized codebook that prioritizes minimal processing over maximum compression, extending battery life while maintaining essential communication.

According to an aspect, extending the system to work across multiple chips can broaden its applicability in complex computing systems, such as multi-core processors or distributed computing environments. This feature may be implemented by creating a standardized protocol for codebook sharing and synchronization across different chips. The existing firmware can be expanded to include inter-chip communication modules, allowing for the exchange of codebook updates and ensuring consistency across all chips in a system. For instance, in a multi-chip module, one chip could act as a master, periodically broadcasting codebook updates to all other chips. This would ensure that all chips in the system are using the same encoding scheme, allowing for seamless data transfer between different components of a larger computing system.

According to some embodiments, using more advanced machine learning techniques to continuously refine the codebook based on actual usage patterns can significantly improve the system's adaptability and efficiency over time. This feature may be implemented by incorporating a lightweight machine learning model, such as a simple neural network or decision tree, into the firmware. The model can analyze the frequency and patterns of data being transmitted between processors, continuously updating the codebook to optimize for current usage. For example, the system could track which codewords are used most frequently and periodically reorganize the codebook to assign shorter codewords to the most common patterns. Over time, this would lead to a highly optimized, application-specific encoding scheme that maximizes compression efficiency for the particular workloads running on the chip.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “byte” refers to a series of bits exactly eight bits in length.

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data” means information in any computer-readable form.

The term “data set” refers to a grouping of data for a particular purpose. One example of a data set might be a word processing file containing text and formatting information.

The term “effective compression” or “effective compression ratio” refers to the additional amount data that can be stored using the method herein described versus conventional data storage methods. Although the method herein described is not data compression, per se, expressing the additional capacity in terms of compression is a useful comparison.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

### Conceptual Architecture

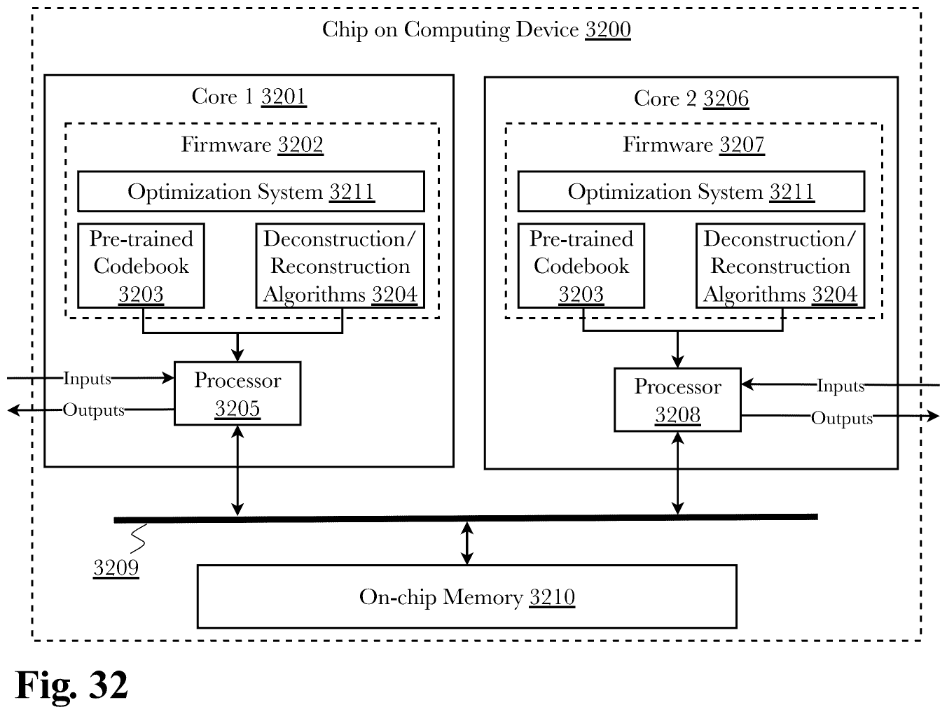

FIG. 32 is a diagram showing an exemplary embodiment in which a pre-trained version of the codebook library, associated algorithms, and a codebook optimization system are encoded as firmware on a semiconductor multi-core processing chip 3200 included as part of the hardware of a plurality of devices. According to an embodiment, a semiconductor, such as a multi-core processing chip 3200, may have two or more processing cores 3201, 3206 which may pass data between and among the cores using a data bus 3209. As more and more processors are used to perform tasks, larger portion of the resources and cost is used to transport bits between processors. This cost is proportional to the number of bits/second that need to be transported. The cost is high for data transport between processor components where the data travels across circuit board traces. In order to reduce the cost of intra-chip (on-chip) data transportation between processing cores, a pre-trained codebook 3203 and algorithms 3204, which are lightweight code, may be embedded or programmed into firmware 3202, 3207 in a semiconductor. The system works by using training data to identify patterns in data prior to embedding code or programming firmware in a semiconductor. These patterns and their associated, smaller indices, or codewords, are stored in a codebook 3203 that is replicated on both the sending and receiving bus, along with lightweight code comprising the deconstruction and reconstruction algorithms 3204. In processing live data, only codewords, much smaller than the original data, are transferred between buses.

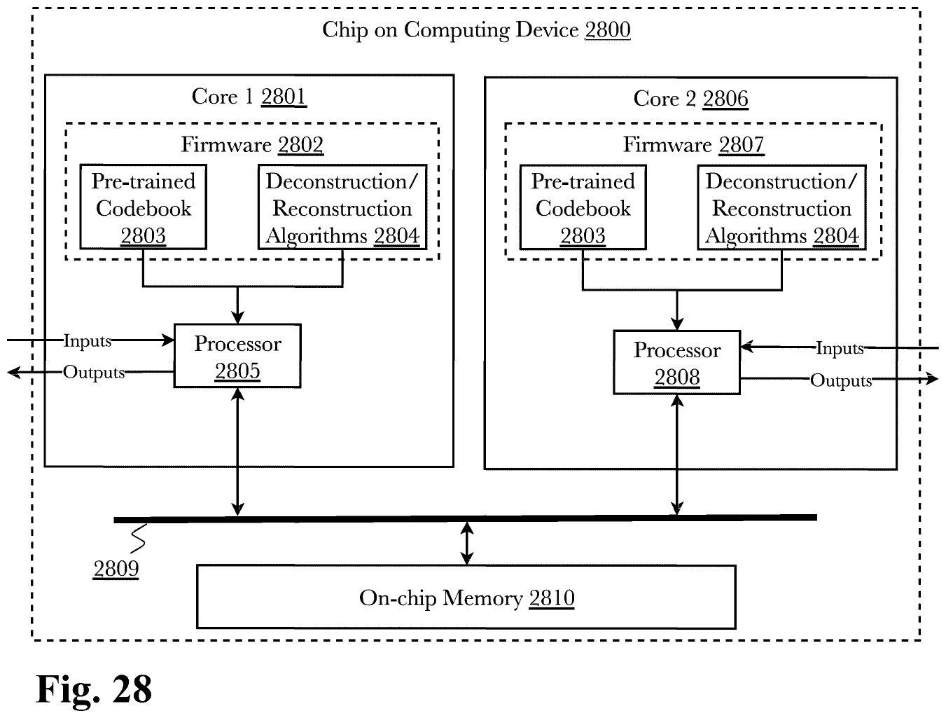

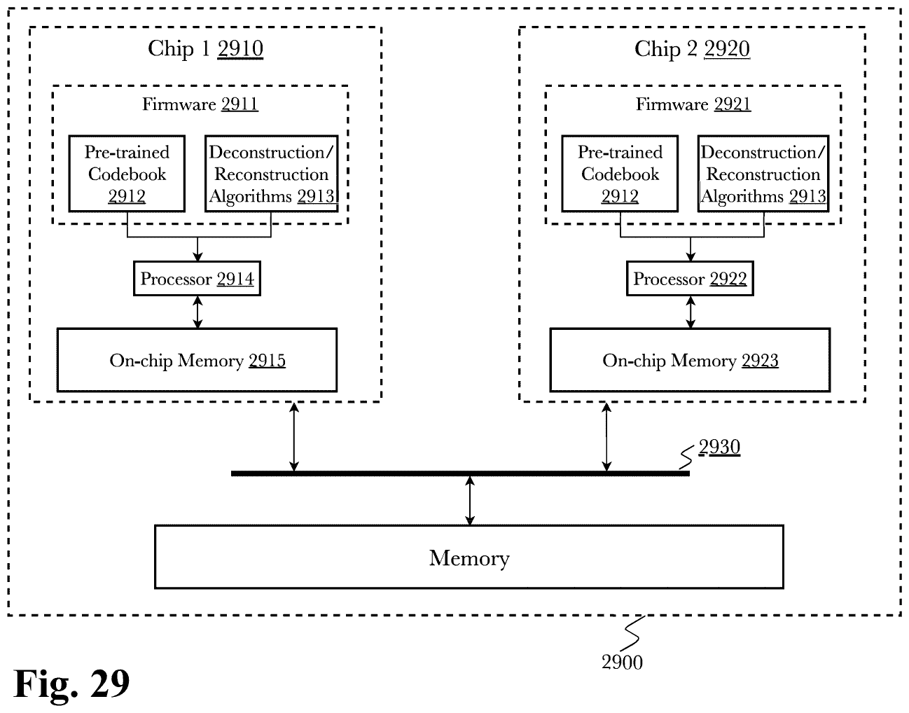

A machine learning optimization system 3211 for codebook refinement is present and can be seamlessly integrated into the multi-core processing chip architecture depicted in FIG. 28 and FIG. 32 or into a multi-chip module as described in FIG. 29. This integration can enhance the chip's ability to efficiently handle intrachip communications by dynamically improving the codebook over time. The optimization system can be incorporated as part of firmware 3202, 3207 stored in each core 3201, 3206, working in conjunction with the existing pre-trained codebook 3203 and deconstruction/reconstruction algorithms 3204. As processors 3205, 3208 handle data and facilitate transmission between cores via data bus 3209, optimization system 3211 can continuously collect usage data about the codebook. This data collection process may be tightly integrated into the existing deconstruction and reconstruction processes, ensuring minimal overhead.

Optimization system 3211 may comprise feature extraction and machine learning model components that operate as background processes on the processors 3205, 3208. These processes can analyze the collected data to identify patterns in codebook usage, data transmission characteristics, and communication contexts. Based on this analysis, a machine learning model can generate recommendations for codebook updates. These recommendations may be used to refine the pre-trained codebook 3203 in real-time, with updates implemented in a manner that ensures thread safety and minimal disruption to ongoing communications. To maintain consistency across the chip, when updates are made to the codebook, a synchronization mechanism can ensure that all cores are using the same version of the codebook for their communications.

Performance monitoring may be performed as part of the optimization system's operation. As data is processed and transmitted between cores, the system can continuously track metrics such as compression ratio, encoding/decoding speed, and frequency of codebook misses. This monitoring provides useful feedback for the machine learning model(s), allowing it to assess the effectiveness of recent codebook updates and inform future optimization decisions. The on-chip memory 3210 can be utilized for storing temporary data required by optimization system 3211, such as recent usage statistics, intermediate results of the machine learning model, and perhaps a small buffer of recent codebook versions to allow for quick rollback if needed.

To ensure optimal operation across various chip states, optimization system 3211 can interface with the chip's power management systems. This can allow the system to adjust its operations based on the current power state of the chip. For example, during low-power states, the system might reduce the frequency of codebook updates or switch to a less computationally intensive version of its machine learning model. Conversely, when ample power is available, the system could perform more aggressive optimization. This power-aware operation can help balance the goals of communication efficiency and energy conservation.

The integration of this optimization system into the multi-core processing chip architecture provides several key benefits. It allows for continuous improvement of intrachip communication efficiency, adapting to the specific data patterns and communication needs of the applications running on the chip. By leveraging machine learning techniques, the system can identify and exploit patterns that might not be apparent in initial statistical analyses, potentially leading to significant improvements in compression ratios and communication speeds over time. Furthermore, the system's ability to adapt in real-time means that it can respond to changes in data patterns or communication requirements as they occur, ensuring that the chip maintains optimal performance even as its usage evolves. This dynamic, adaptive approach to codebook optimization represents a significant advancement over static, pre-trained codebooks, potentially leading to substantial improvements in overall chip performance and energy efficiency.

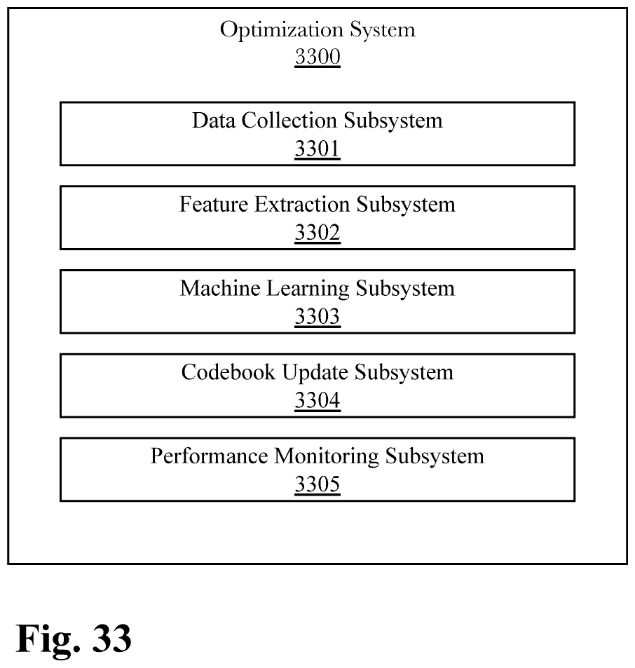

FIG. 33 is a block diagram illustrating an exemplary aspect of a component of a dynamic codebook refinement and optimization system, a machine learning optimization system 3300. According to the embodiment, the machine learning optimization system for codebook refinement is designed to continuously improve the efficiency of the intra-chip communication system by adapting the codebook to actual usage patterns. This system comprises five main components: a data collection subsystem 3301, a feature extraction subsystem 3302, a machine learning subsystem 3303, a codebook update subsystem 3304, and a performance monitoring subsystem 3305. In various embodiments, each of these components plays a role in the ongoing optimization process. The subsystems described herein may also be referred to as modules or components interchangeably.

Data collection subsystem 3301 serves as the foundation of the system, continuously sampling and storing data about the usage of the current codebook. This module collects information such as the frequency of each codeword's usage, patterns of sourceblocks that don't match existing codewords, temporal patterns of data transmission, and the size of data packets being transmitted. This module can be integrated into the existing deconstruction and reconstruction algorithms, for example logging relevant information to a circular buffer in the chip's memory each time a sourceblock is encoded or decoded.

According to an embodiment, the system implements continuous data collection by integrating data logging functionality directly into the encoding and decoding processes of the intrachip communication system. This can be achieved by adding a lightweight logging module to data collection subsystem 3301 that captures relevant data points each time a codeword is used or a sourceblock is processed. For example, the module can use a circular buffer in memory to store recent usage data, with a separate thread periodically transferring this data to a more permanent storage for later analysis. To minimize impact on communication performance, the logging can be implemented using lock-free data structures to avoid contention between the communication and logging processes.

Working in tandem with data collection subsystem 3301, feature extraction subsystem 3302 processes the raw data into features that can be used by one or machine learning models via machine learning subsystem 3303. This subsystem can be configured to run periodically, computing features such as moving averages of codeword frequencies, entropy of recent data transmissions, ratios of matched to unmatched sourceblocks, and time-based features if relevant to the chip's usage patterns. These extracted features provide a comprehensive representation of the current state and trends of the codebook's performance.

According to an embodiment, feature extraction can be implemented as a separate module that processes the logged data at regular intervals. This module can use efficient algorithms to calculate statistics such as frequency distributions of codeword usage, identify patterns of unmatched sourceblocks, and detect temporal patterns in data transmission. For frequency analysis, a hash table can be used to quickly count occurrences of each codeword. Unmatched sourceblock patterns can be identified using a trie data structure to efficiently store and match prefixes. Temporal patterns can be detected using sliding window algorithms that maintain statistics over different time scales.

According to the embodiment, machine learning subsystem 3303 is present and configured to train, maintain, and deploy one or more machine learning models to support codebook optimization processes. Given the constraints of running on-chip, the one or more models are specifically trained to be lightweight and efficient. Exemplary models may comprise a simple neural network with one or two hidden layers, a decision tree or random forest, or an online learning algorithm like stochastic gradient descent. The model takes the extracted features as input and outputs recommendations for codebook updates. It can be pre-trained offline on simulated or historical data and then fine-tuned on-chip using the collected real-world data and/or incremental learning techniques.

According to an embodiment, to ensure on-chip efficiency, the one or more machine learning models can be implemented using techniques optimized for embedded systems. This could involve using a decision tree with a limited depth, or a small neural network with quantized weights. Model inference can be optimized using techniques like loop unrolling and vectorization to take advantage of the specific hardware capabilities of the chip.

Incremental training can be implemented using online learning algorithms such as stochastic gradient descent. The machine learning model can maintain a set of sufficient statistics that summarize the data it has seen so far. When new data arrives, these statistics can be updated efficiently without needing to store or reprocess old data. The model parameters can then be adjusted based on these updated statistics. This process can be made thread-safe using fine-grained locking or lock-free data structures to allow concurrent updates and inference.

According to an embodiment, synthetic data generation can be implemented using a generative model trained offline on expected data patterns. This model could be a simple Markov chain for generating sequences of sourceblocks, or a more complex generative adversarial network for producing realistic data patterns. The synthetic data generation process can run as a low-priority background task during the system's initial operation phase, gradually building up a dataset that complements the real data being collected.

According to the aspect, codebook update subsystem 3304 acts on the recommendations provided by the one or more ML models, applying changes to the codebook 3203 stored in firmware. This subsystem may be responsible for adding new codewords for frequently occurring unmatched sourceblocks, removing or consolidating rarely used codewords, and adjusting the bit-length of codewords based on their frequency of use. The subsystem ensures that any changes maintain the integrity of the encoding scheme, avoiding conflicts between codewords.

According to an embodiment, real-time adaptation can be implemented by running the codebook update process as a continuous background task. This task can periodically (e.g., every few milliseconds) check for new feature data, run the machine learning model to generate update recommendations, and apply small changes to the codebook. To ensure minimal disruption to ongoing communications, updates can be applied using a double-buffering technique, where changes are made to a copy of the codebook which is then swapped in atomically.

According to an embodiment, gradual updates can be implemented by incorporating a rate-limiting mechanism in the codebook update process. This mechanism can adjust the frequency and magnitude of updates based on recent performance trends. For example, it could use an exponential moving average of recent performance metrics to determine an “update budget”, limiting the number or size of codebook changes allowed in a given time period. If performance is stable, the budget increases, allowing for more aggressive optimization; if performance is volatile, the budget decreases, favoring stability.

According to an embodiment, security can be implemented using a public-key cryptography system. Each codebook update can be signed with a private key held securely off-chip. The on-chip system can verify these signatures using a public key embedded in its firmware. This verification process can be integrated into the codebook update mechanism, rejecting any updates that fail signature verification. To prevent replay attacks, each update can include a monotonically increasing sequence number.

According to an embodiment, a multi-level codebook system can be implemented by maintaining multiple codebooks in memory, each optimized for different types of data or different parts of the chip. A selection mechanism chooses the appropriate codebook based on context. This mechanism may use a decision tree or a small neural network that takes as input features of the current communication context (e.g., source/destination of the data, type of data being transmitted) and outputs the index of the most appropriate codebook. The selection process can be optimized using caching techniques to avoid re-computation for frequently occurring contexts.

Performance monitoring module 3305 tracks the performance of the codebook over time, measuring metrics such as compression ratio, encoding/decoding speed, and frequency of codebook misses. According to an embodiment, this module computes these metrics continuously and stores them in a rolling window, providing feedback to ML subsystem 3303 to help evaluate the effectiveness of recent changes.

According to an aspect, performance monitoring subsystem 3305 can maintain running averages of compression ratios and encoding/decoding speeds using efficient online algorithms. Codebook miss rates can be tracked using a simple counter incremented each time an unmatched sourceblock is encountered. The module can periodically (e.g., every second) calculate aggregate statistics and store them in a circular buffer for trend analysis.

According to an embodiment, a fallback mechanism can be implemented by maintaining two codebooks in memory: the actively optimized one and a conservative, pre-trained one. A monitoring thread can continuously compare the performance of the active codebook against a predefined threshold. If performance falls below this threshold for a sustained period (e.g., several seconds), the system can switch to the conservative codebook. This switch can be implemented using atomic operations to ensure thread safety. The system can periodically attempt to switch back to the optimized codebook, with a backoff mechanism to avoid frequent switching.

According to an embodiment, power optimization can be achieved by implementing a power state monitoring subsystem (which may be a component of performance monitoring subsystem 3305) that interfaces with the chip's power management unit. This subsystem can adjust the frequency and complexity of codebook refinement operations based on the current power state. For example, in low-power states, it might reduce the frequency of updates or switch to a simpler, less computationally intensive machine learning model. These adjustments can be implemented using a lookup table that maps power states to optimization parameters.

Performance monitoring subsystem 3305 can be configured to support anomaly detection use cases. According to an aspect, anomaly detection can be implemented using statistical models of normal codebook usage patterns. These models can include, but are not limited to, distributions of codeword frequencies, typical patterns of codebook updates, and expected performance metrics. The system can maintain these models using online learning techniques, continuously updating them based on observed data. A separate anomaly detection thread can periodically compare recent activity against these models, using techniques like Gaussian mixture models or isolation forests to identify outliers. When potential anomalies are detected, the system can raise alerts or trigger more in-depth analysis.

The execution flow of this system involves a continuous cycle of data collection, feature extraction, model prediction, codebook updating, and performance monitoring. As an example, consider a multi-core processor chip using the optimization system for intra-chip communication. Over the course of an hour, the data collection module observes that a particular sequence of bits, representing a specific instruction, is being transmitted frequently between two cores. This sequence doesn't match any existing codeword in the codebook.

At the end of the hour, the feature extraction subsystem processes this data, noting the high frequency of this unmatched sequence along with other relevant features. One or more machine learning models, taking these features as input, recommends adding a new codeword for this frequent sequence and adjusting the bit-lengths of some existing codewords to maintain optimal Huffman coding.

The codebook update subsystem then implements these changes, adding the new codeword and adjusting others. Over the next hour, the performance monitoring subsystem observes that these changes have resulted in a 5% improvement in the overall compression ratio and a 3% increase in encoding/decoding speed.

This information is fed back into the system, reinforcing the effectiveness of the recent changes. The cycle then continues, with the system constantly adapting to the changing patterns of data transmission between the processor cores. Over time, this ongoing optimization can lead to significant improvements in the efficiency of intra-chip communication, potentially enhancing overall system performance.

To address the resource constraints inherent in on-chip machine learning, several strategies can be employed in various embodiments. Lightweight ML models, such as decision trees or small neural networks with only one or two hidden layers, can be used instead of traditional deep learning models. For example, a simple decision tree could effectively classify incoming data patterns and suggest codebook updates while significantly reducing computational overhead. Incremental learning algorithms can update model parameters based only on new data, rather than retraining the entire model from scratch. Stochastic gradient descent, for instance, can be used to adjust model weights incrementally, drastically reducing memory usage and computational load. This makes it particularly suitable for continuous learning in resource-constrained environments. Asynchronous processing can be implemented by scheduling ML tasks during processor idle times or at a lower priority. A simple scheduler could trigger ML optimization tasks only when processor utilization falls below a certain threshold, say 70%, ensuring that critical chip functions are not impacted.

Hardware partitioning is another effective strategy for managing resource constraints which may be implemented in some embodiments. Dedicating a small portion of the chip's resources, such as a specific core or a dedicated area of memory, ensures that the ML subsystem has guaranteed resources without interfering with main processes. This could be implemented using hardware virtualization techniques, effectively creating a “virtual machine” for the ML system within the chip. Quantization can also significantly reduce both computation time and memory usage. Using lower precision arithmetic, such as 8-bit integers instead of 32-bit floating point numbers, can achieve substantial efficiency gains. For example, weights in a neural network could be quantized from float32 to int8, potentially sacrificing a small amount of accuracy for a large gain in efficiency.

Maintaining stability in the face of frequent codebook changes is important for the system's overall performance. Implementing gradual updates, where the system modifies, for example, no more than 1% of the codebook in any given update cycle, can prevent drastic changes that could potentially destabilize the system. According to an aspect, a hysteresis mechanism can be utilized by requiring that a proposed change exceed a certain threshold before being implemented. For instance, the system might stipulate that a proposed codebook change must demonstrate a 5% improvement in compression ratio over a 24-hour period before being applied. This approach helps avoid making unnecessary updates based on noise or temporary fluctuations. According to an embodiment, implementing a quick rollback mechanism allows the system to revert to a previous, known-good state if performance degrades. This could be achieved by maintaining a small number (e.g., the last 3) of recent codebook versions in memory, allowing for quick switching if needed.

Long-term trend analysis using techniques like exponential moving averages can help distinguish genuine trends from short-term fluctuations. For example, using a 7-day exponential moving average of the compression ratio could guide decision-making about codebook updates. A/B testing is another valuable strategy for maintaining stability. Before implementing a change system-wide, the system can test it on a small subset of the data or processors. A proposed codebook update might be applied to 10% of the data streams for a 24-hour period, with the change only being rolled out more widely if it demonstrates improvement.

The cold start problem, where the system initially lacks sufficient data for meaningful optimization, can be mitigated through several approaches. Starting with a pre-trained model based on simulated or historical data provides a reasonable starting point. This model could be trained offline using data from similar systems or synthetic data generated to mimic expected patterns. Beginning with a conservative, general-purpose codebook that performs adequately across various data types ensures acceptable initial performance. This could be based on statistical analysis of common data patterns in similar systems. Implementing a higher learning rate in the early stages allows the system to quickly adapt to its specific use case. For example, the learning rate could start at 0.1 and gradually decrease to 0.01 over the first week of operation.

In some aspects, including a standard, non-ML-optimized encoding scheme as a fallback ensures that the system can still function effectively even if the ML system's performance is initially suboptimal. The system could automatically switch to this fallback if the ML-optimized performance falls below a certain threshold. Synthetic data generation techniques like data augmentation can help generate additional training data in the early stages. For instance, the system could apply small perturbations to observed data patterns to create similar, but slightly different, training examples, accelerating the learning process.

Rate limiting can be an effective security measure, placing restrictions on how quickly and how much the codebook can change. For example, the system might be limited to no more than one major codebook update per day, making it harder for an attacker to manipulate the system rapidly. Employing diversity in learning through ensemble methods or federated learning approaches can make the system more robust against targeted attacks. Maintaining multiple models and using a voting system to determine updates can prevent a single compromised model from negatively impacting the entire system. Periodic resets to a known-good codebook state can limit the potential impact of a long-term, subtle attack. This could involve reverting to a baseline codebook (stored in read-only memory) once per month, for example.

By implementing one or more of these strategies, machine learning optimization system 3300 can operate efficiently within the chip's constraints, maintain stability over time, overcome cold start issues, and resist potential security threats. The specific implementation of these strategies can be carefully tuned based on the characteristics of the chip and its intended use, with ongoing monitoring and adjustment to ensure continued effectiveness.

By implementing this machine learning optimization system 3300, the codebook can continuously evolve to better match the actual data patterns being transmitted between processors. This adaptive approach has the potential to lead to significant improvements in compression efficiency and overall system performance over time, making it a valuable addition to the intra-chip communication system described in the patent.

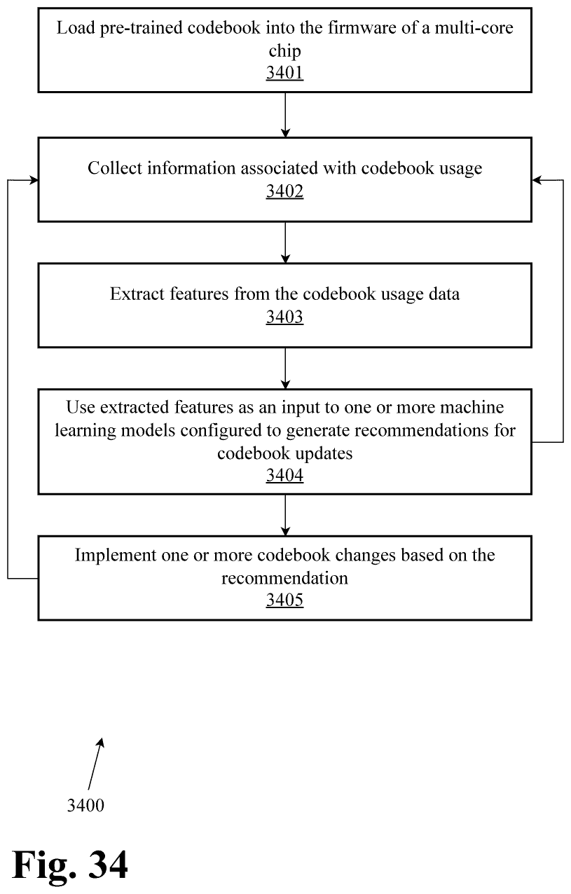

FIG. 34 is a flow diagram illustrating an exemplary method 3400 for optimizing codebook refinement in intrachip communications, according to an embodiment. According to the embodiment, the process begins at step 3401 with the initialization of the system, where a pre-trained codebook is loaded into the firmware of each core on the multi-core processing chip. This initial codebook is based on statistical analysis of expected data patterns and serves as a starting point for optimization. Additionally, a lightweight machine learning model, designed for efficient on-chip execution, is initialized. The system then enters a continuous optimization loop, which operates in parallel with normal intrachip communication processes. As data is transmitted between cores, a data collection subsystem integrated into the encoding and decoding processes captures relevant information about codebook usage at step 3402. This may comprise frequency of codeword usage, patterns of unmatched sourceblocks, and temporal patterns of data transmission. The collected data is temporarily stored in, for example, a circular buffer in the chip's on-board memory, with a separate thread periodically processing this raw data to extract meaningful features at step 3403.

The feature extraction process may comprise calculating statistics such as moving averages of codeword frequencies, entropy of recent data transmissions, and ratios of matched to unmatched sourceblocks. These extracted features serve as input to a machine learning model at step 3404, which analyzes them to generate recommendations for codebook updates. The model is designed to identify patterns that could lead to improved compression ratios or communication efficiency. Simultaneously, a performance monitoring subsystem tracks key metrics such as compression ratio, encoding/decoding speed, and frequency of codebook misses. These performance metrics may be used both as additional input to the machine learning model and as a means of evaluating the effectiveness of recent codebook updates.

Based on the recommendations from the machine learning model and the current performance metrics, a codebook update subsystem implements changes to the codebook at step 3405. These updates may be applied gradually to maintain system stability, with the rate of change dynamically adjusted based on the monitored performance metrics. According to an aspect, the update process uses a double-buffering technique to minimize disruption to ongoing communications, making changes to a copy of the codebook which is then swapped in atomically. To ensure security, each update may cryptographically signed, and the system verifies these signatures before applying any changes. The system may be further configured to implement a fallback mechanism in some embodiments, maintaining a conservative, pre-trained codebook that can be quickly swapped in if performance degrades significantly.

The machine learning model itself is continuously refined through incremental learning, adjusting its parameters based on the outcomes of its recommendations. This allows the model to improve its predictive capabilities over time without the need for offline retraining. According to an aspect, the system implements power optimization by adjusting the frequency and complexity of its operations based on the current power state of the chip, as reported by the chip's power management unit. In low-power states, the system might reduce the frequency of updates or switch to a simpler version of its machine learning model.

To handle the cold start problem and accelerate initial optimization, the system may be configured to employs synthetic data generation techniques during its early operation phase. This may comprise using a pre-trained generative model to create artificial but statistically similar data patterns, supplementing the real data being collected. As an additional security measure, the system may be configured to implement an anomaly detection mechanism that identifies unusual patterns in codebook usage or update requests, flagging potential security threats for further investigation.

This method describes a robust, adaptive system for codebook optimization in intrachip communications. By continuously learning from actual usage patterns and adjusting its strategies accordingly, the method can significantly improve communication efficiency over time, leading to enhanced overall chip performance and energy efficiency.

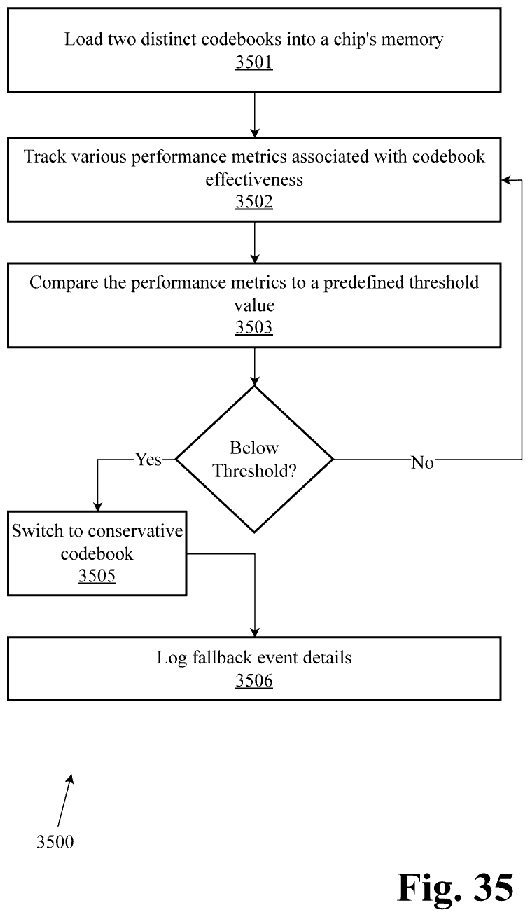

FIG. 35 is a flow diagram illustrating an exemplary method 3500 for implementing a fallback mechanism, according to an embodiment. According to the embodiment, the process begins during the initialization phase of the codebook optimization system. At this step 3501, two distinct codebooks are loaded into the chip's memory: the primary, dynamically optimized codebook, and a secondary, conservative codebook. The conservative codebook is pre-trained on a wide range of general data patterns and is designed to provide reliable, if not optimal, performance across various scenarios. This conservative codebook remains static throughout the chip's operation, serving as a safe fallback option. Alongside these codebooks, the system initializes a performance monitoring module and a codebook selection mechanism.

A performance monitoring subsystem continuously tracks key metrics related to the codebook's effectiveness at step 3502. These metrics may comprise the compression ratio achieved, the encoding and decoding speeds, and the frequency of codebook misses (instances where no matching codeword is found for a given sourceblock). The subsystem can calculate rolling averages of these metrics over various time windows-short-term (e.g., last 100 milliseconds), medium-term (e.g., last second), and long-term (e.g., last 10 seconds). These multi-timescale averages help distinguish between transient fluctuations and sustained performance issues.

A codebook selection mechanism operates as a separate thread, periodically evaluating the performance metrics against predefined thresholds at step 3503. These thresholds may be initially set based on the performance of the conservative codebook but can be dynamically adjusted over time as the system learns about its operational environment. If the performance metrics fall below these thresholds for a sustained period (e.g., if the compression ratio drops below 90% of the conservative codebook's performance for more than 500 milliseconds), the selection mechanism triggers a switch to the conservative codebook at step 3505.

The actual switching process can be designed to be atomic and thread-safe to prevent any inconsistencies during ongoing communications. When a switch is triggered, the system first completes any in-progress encoding or decoding operations using the current codebook. It can then use a double-buffering technique to swap the active codebook pointer to the conservative codebook. This swap is performed using atomic operations to ensure that all cores and threads immediately see the change. Following the switch, the system logs the event (e.g., fallback event) at step 3506, including the performance metrics that triggered it, for later analysis.

According to an aspect, after switching to the conservative codebook, the system enters a cool-down period, during which it continues to monitor performance but does not attempt to switch back to the optimized codebook. This cool-down period helps prevent rapid oscillation between codebooks. Once the cool-down period expires, the system begins a gradual transition back to the optimized codebook. This transition may start, for example, by using the optimized codebook for a small percentage of operations (e.g., 10%) and gradually increasing this percentage over time, as long as performance metrics remain above the thresholds.

Throughout this process, the machine learning model(s) continues to refine the optimized codebook based on ongoing data collection and analysis. This ensures that when the system fully transitions back to the optimized codebook, it has potentially addressed the issues that caused the performance degradation. Additionally, the system uses the logged data from fallback events to adjust its optimization strategies, potentially becoming more conservative in scenarios that have previously led to performance issues.

According to an embodiment, the fallback mechanism also includes a manual override option, allowing system administrators to force the use of either codebook if necessary. This can be useful for debugging purposes or in scenarios where deterministic behavior is temporarily more critical than optimal performance. Finally, the system implements a secure update mechanism for the conservative codebook itself. While updates to this codebook are expected to be rare, the mechanism ensures that any such updates are cryptographically signed and thoroughly validated before being applied, maintaining the integrity of this crucial safety net.

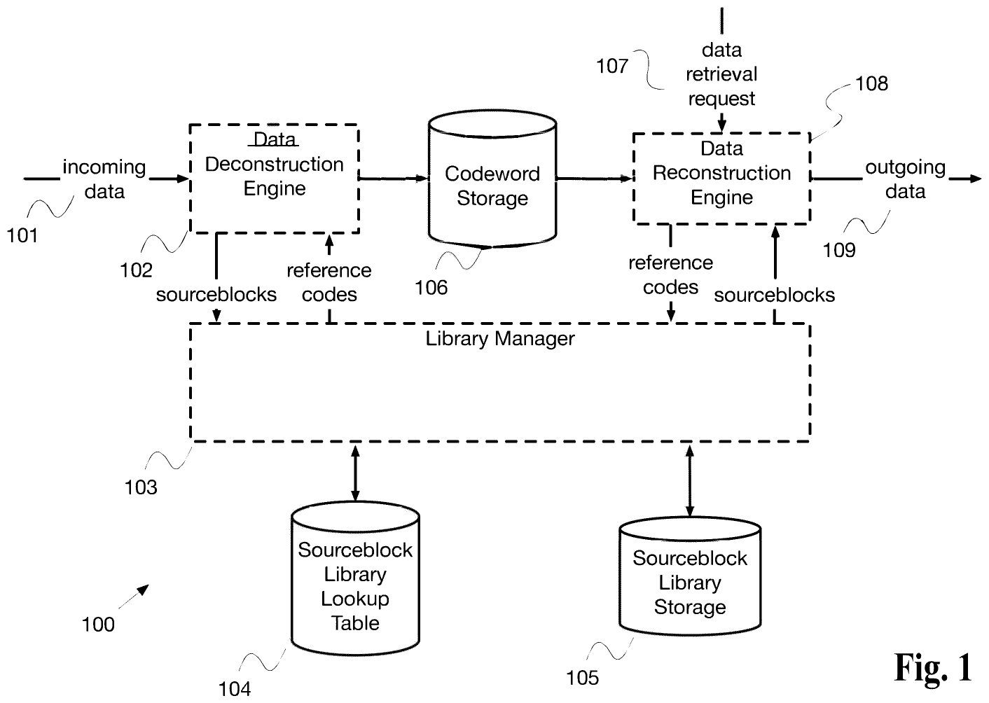

FIG. 1 is a diagram showing an embodiment 100 of the system in which all components of the system are operated locally. As incoming data 101 is received by data deconstruction engine 102. Data deconstruction engine 102 breaks the incoming data into sourceblocks, which are then sent to library manager 103. Using the information contained in sourceblock library lookup table 104 and sourceblock library storage 105, library manager 103 returns reference codes to data deconstruction engine 102 for processing into codewords, which are stored in codeword storage 106. When a data retrieval request 107 is received, data reconstruction engine 108 obtains the codewords associated with the data from codeword storage 106, and sends them to library manager 103. Library manager 103 returns the appropriate sourceblocks to data reconstruction engine 108, which assembles them into the proper order and sends out the data in its original form 109.

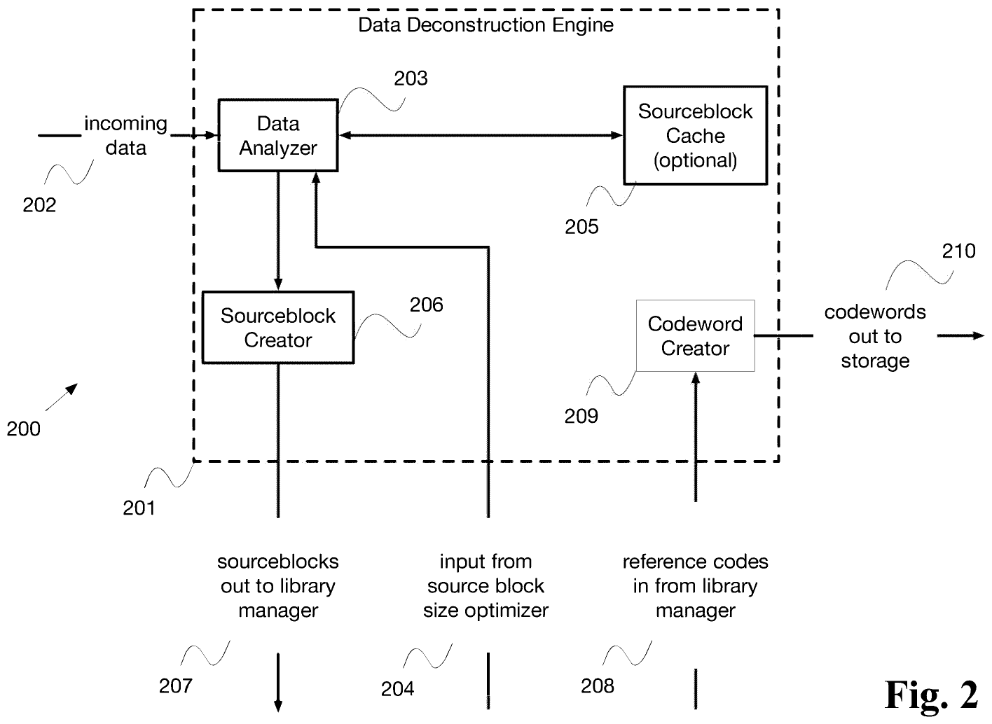

FIG. 2 is a diagram showing an embodiment of one aspect 200 of the system, specifically data deconstruction engine 201. Incoming data 202 is received by data analyzer 203, which optimally analyzes the data based on machine learning algorithms and input 204 from a sourceblock size optimizer, which is disclosed below. Data analyzer may optionally have access to a sourceblock cache 205 of recently-processed sourceblocks, which can increase the speed of the system by avoiding processing in library manager 103. Based on information from data analyzer 203, the data is broken into sourceblocks by sourceblock creator 206, which sends sourceblocks 207 to library manager 203 for additional processing. Data deconstruction engine 201 receives reference codes 208 from library manager 103, corresponding to the sourceblocks in the library that match the sourceblocks sent by sourceblock creator 206, and codeword creator 209 processes the reference codes into codewords comprising a reference code to a sourceblock and a location of that sourceblock within the data set. The original data may be discarded, and the codewords representing the data are sent out to storage 210.

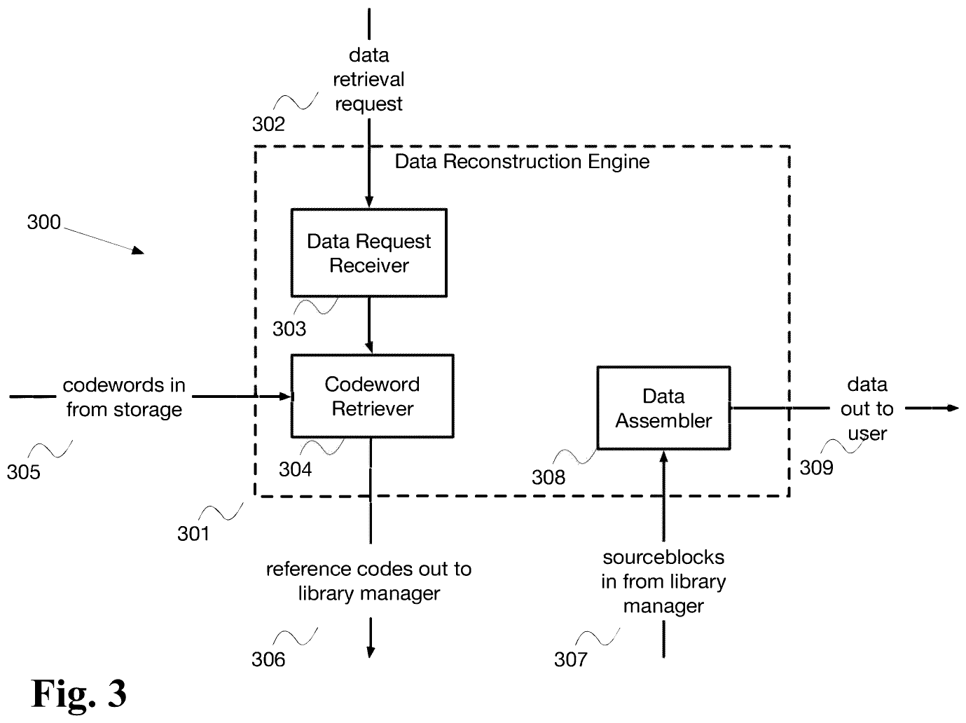

FIG. 3 is a diagram showing an embodiment of another aspect of system 300, specifically data reconstruction engine 301. When a data retrieval request 302 is received by data request receiver 303 (in the form of a plurality of codewords corresponding to a desired final data set), it passes the information to data retriever 304, which obtains the requested data 305 from storage. Data retriever 304 sends, for each codeword received, a reference codes from the codeword 306 to library manager 103 for retrieval of the specific sourceblock associated with the reference code. Data assembler 308 receives the sourceblock 307 from library manager 103 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 309 in its original form.

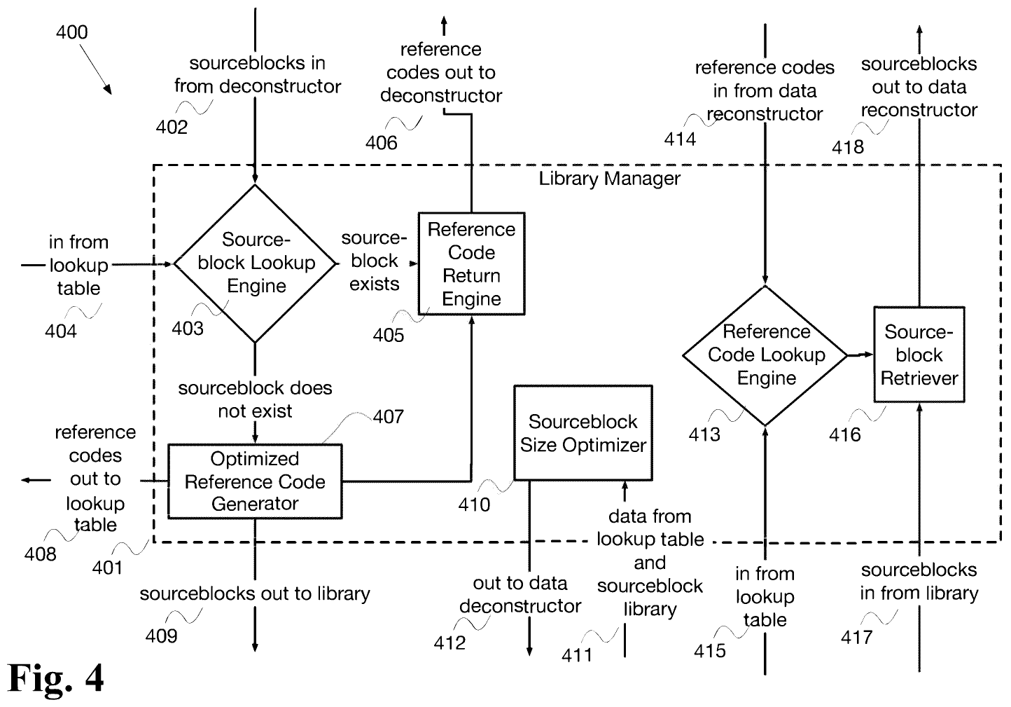

FIG. 4 is a diagram showing an embodiment of another aspect of the system 400, specifically library manager 401. One function of library manager 401 is to generate reference codes from sourceblocks received from data deconstruction engine 301. As sourceblocks are received 402 from data deconstruction engine 301, sourceblock lookup engine 403 checks sourceblock library lookup table 404 to determine whether those sourceblocks already exist in sourceblock library storage 105. If a particular sourceblock exists in sourceblock library storage 105, reference code return engine 405 sends the appropriate reference code 406 to data deconstruction engine 301. If the sourceblock does not exist in sourceblock library storage 105, optimized reference code generator 407 generates a new, optimized reference code based on machine learning algorithms. Optimized reference code generator 407 then saves the reference code 408 to sourceblock library lookup table 104; saves the associated sourceblock 409 to sourceblock library storage 105; and passes the reference code to reference code return engine 405 for sending 406 to data deconstruction engine 301. Another function of library manager 401 is to optimize the size of sourceblocks in the system. Based on information 411 contained in sourceblock library lookup table 104, sourceblock size optimizer 410 dynamically adjusts the size of sourceblocks in the system based on machine learning algorithms and outputs that information 412 to data analyzer 203. Another function of library manager 401 is to return sourceblocks associated with reference codes received from data reconstruction engine 301. As reference codes are received 414 from data reconstruction engine 301, reference code lookup engine 413 checks sourceblock library lookup table 415 to identify the associated sourceblocks; passes that information to sourceblock retriever 416, which obtains the sourceblocks 417 from sourceblock library storage 105; and passes them 418 to data reconstruction engine 301.

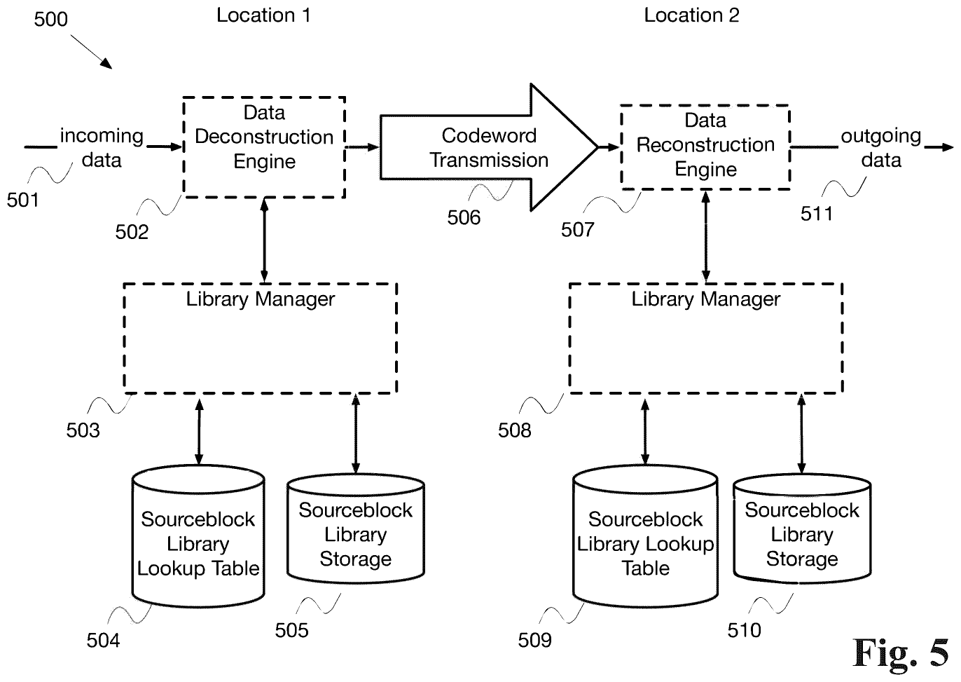

FIG. 5 is a diagram showing another embodiment of system 500, in which data is transferred between remote locations. As incoming data 501 is received by data deconstruction engine 502 at Location 1, data deconstruction engine 301 breaks the incoming data into sourceblocks, which are then sent to library manager 503 at Location 1. Using the information contained in sourceblock library lookup table 504 at Location 1 and sourceblock library storage 505 at Location 1, library manager 503 returns reference codes to data deconstruction engine 301 for processing into codewords, which are transmitted 506 to data reconstruction engine 507 at Location 2. In the case where the reference codes contained in a particular codeword have been newly generated by library manager 503 at Location 1, the codeword is transmitted along with a copy of the associated sourceblock. As data reconstruction engine 507 at Location 2 receives the codewords, it passes them to library manager module 508 at Location 2, which looks up the sourceblock in sourceblock library lookup table 509 at Location 2, and retrieves the associated from sourceblock library storage 510. Where a sourceblock has been transmitted along with a codeword, the sourceblock is stored in sourceblock library storage 510 and sourceblock library lookup table 504 is updated. Library manager 503 returns the appropriate sourceblocks to data reconstruction engine 507, which assembles them into the proper order and sends the data in its original form 511.

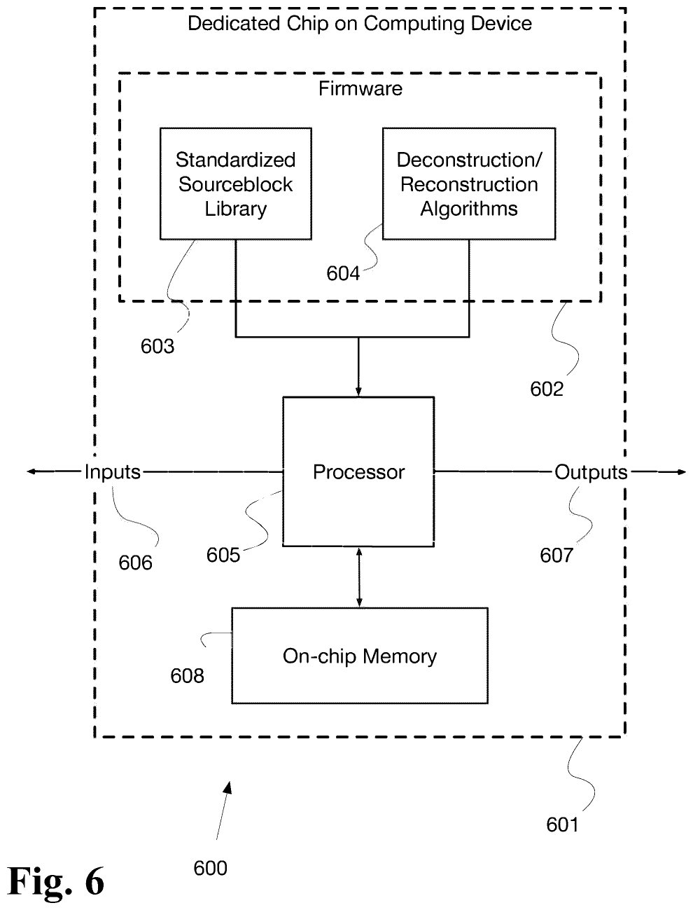

FIG. 6 is a diagram showing an embodiment 600 in which a standardized version of a sourceblock library 603 and associated algorithms 604 would be encoded as firmware 602 on a dedicated processing chip 601 included as part of the hardware of a plurality of devices 600. Contained on dedicated chip 601 would be a firmware area 602, on which would be stored a copy of a standardized sourceblock library 603 and deconstruction/reconstruction algorithms 604 for processing the data. Processor 605 would have both inputs 606 and outputs 607 to other hardware on the device 600. Processor 605 would store incoming data for processing on on-chip memory 608, process the data using standardized sourceblock library 603 and deconstruction/reconstruction algorithms 604, and send the processed data to other hardware on device 600. Using this embodiment, the encoding and decoding of data would be handled by dedicated chip 601, keeping the burden of data processing off device's 600 primary processors. Any device equipped with this embodiment would be able to store and transmit data in a highly optimized, bandwidth-efficient format with any other device equipped with this embodiment.

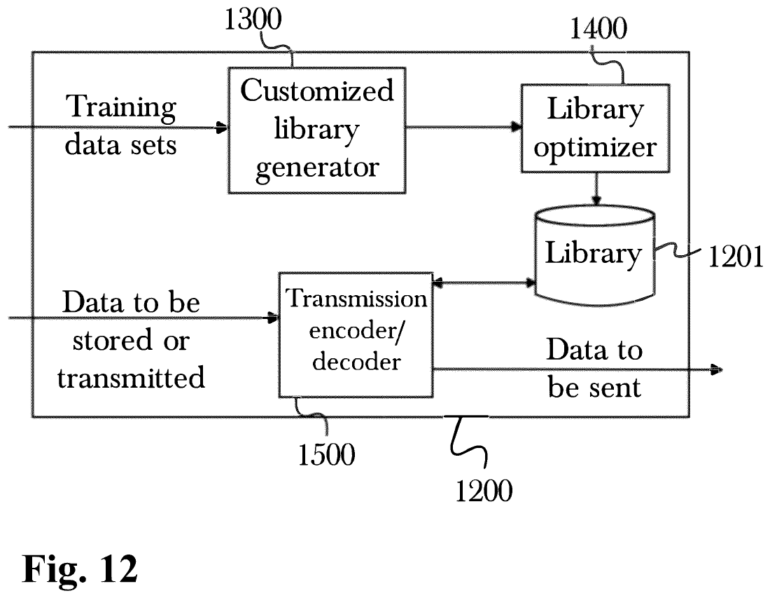

FIG. 12 is a diagram showing an exemplary system architecture 1200, according to a preferred embodiment of the invention. Incoming training data sets may be received at a customized library generator 1300 that processes training data to produce a customized word library 1201 comprising key-value pairs of data words (each comprising a string of bits) and their corresponding calculated binary Huffman codewords. The resultant word library 1201 may then be processed by a library optimizer 1400 to reduce size and improve efficiency, for example by pruning low-occurrence data entries or calculating approximate codewords that may be used to match more than one data word. A transmission encoder/decoder 1500 may be used to receive incoming data intended for storage or transmission, process the data using a word library 1201 to retrieve codewords for the words in the incoming data, and then append the codewords (rather than the original data) to an outbound data stream. Each of these components is described in greater detail below, illustrating the particulars of their respective processing and other functions, referring to FIGS. 2-4.

System 1200 provides near-instantaneous source coding that is dictionary-based and learned in advance from sample training data, so that encoding and decoding may happen concurrently with data transmission. This results in computational latency that is near zero but the data size reduction is comparable to classical compression. For example, if N bits are to be transmitted from sender to receiver, the compression ratio of classical compression is C, the ratio between the deflation factor of system 1200 and that of multi-pass source coding is p, the classical compression encoding rate is R_{C} bit/s and the decoding rate is R_{D} bit/s, and the transmission speed is S′ bit/s, the compress-send-decompress time will be

$${T}_{old} = \frac{N}{{R}_{C}} + \frac{N}{CS} + \frac{N}{{CR}_{D}}$$

while the transmit-while-coding time for system 1200 will be (assuming that encoding and decoding happen at least as quickly as network latency):

$${T}_{new} = \frac{{N}_{p}}{CS} so$$

that the total data transit time improvement factor is

$$\frac{{T}_{old}}{{T}_{new}} = \frac{\frac{CS}{{R}_{C}} + 1 + \frac{S}{{R}_{D}}}{p}$$

which presents a savings whenever

$$\frac{CS}{{R}_{C}} + \frac{S}{{R}_{D}} = 0.053 ... ,$$

This is a reasonable scenario given that typical values in real-world practice are C=0.32, R_{C}=1.1·10¹², R_{D}=4.2·10¹², S=10¹¹, giving

$$\frac{CS}{{R}_{C}} + \frac{S}{{R}_{D}} > p - 1.$$

such that system 1200 will outperform the total transit time of the best compression technology available as long as its deflation factor is no more than 5% worse than compression. Such customized dictionary-based encoding will also sometimes exceed the deflation ratio of classical compression, particularly when network speeds increase beyond 100 Gb/s.

The delay between data creation and its readiness for use at a receiving end will be equal to only the source word length/(typically 5-15 bytes), divided by the deflation factor C/p and the network speed S, i.e.

$${delay}_{invention} = \frac{tp}{CS}$$

since encoding and decoding occur concurrently with data transmission. On the other hand, the latency associated with classical compression is

$${delay}_{priorart} = \frac{N}{{R}_{C}} + \frac{N}{CS} + \frac{N}{{CR}_{D}}$$

where N is the packet/file size. Even with the generous values chosen above as well as N=512K, 1=10, and p=1.05, this results in delayᵢₙᵥₑₙₜᵢₒₙ≈3.3·10⁻¹⁰ while delayₚᵣᵢₒᵣₐᵣₜ≈1.3·10⁻⁷, a more than 400-fold reduction in latency.

A key factor in the efficiency of Huffman coding used by system 1200 is that key-value pairs be chosen carefully to minimize expected coding length, so that the average deflation/compression ratio is minimized. It is possible to achieve the best possible expected code length among all instantaneous codes using Huffman codes if one has access to the exact probability distribution of source words of a given desired length from the random variable generating them. In practice this is impossible, as data is received in a wide variety of formats and the random processes underlying the source data are a mixture of human input, unpredictable (though in principle, deterministic) physical events, and noise. System 1200 addresses this by restriction of data types and density estimation; training data is provided that is representative of the type of data anticipated in “real-world” use of system 1200, which is then used to model the distribution of binary strings in the data in order to build a Huffman code word library 1200.

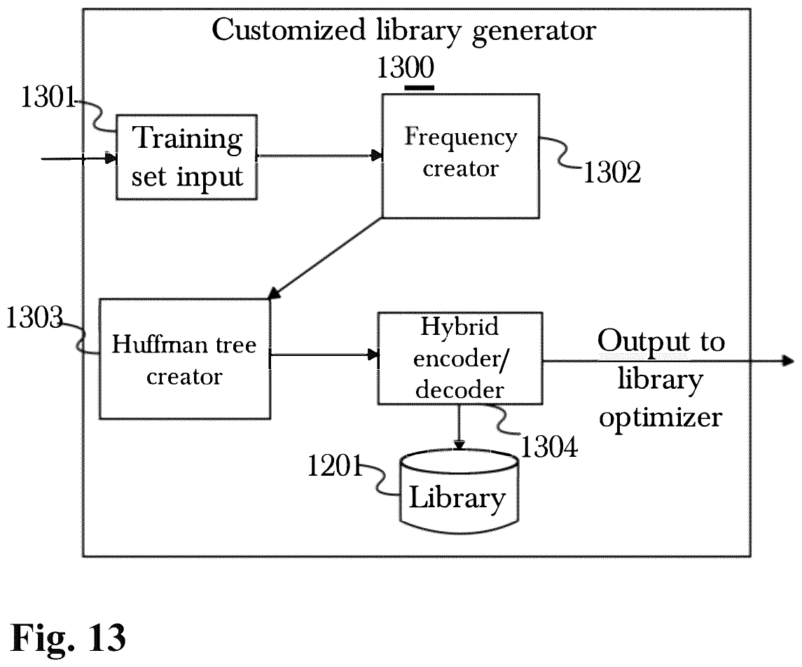

FIG. 13 is a diagram showing a more detailed architecture for a customized library generator 1300. When an incoming training data set 1301 is received, it may be analyzed using a frequency creator 1302 to analyze for word frequency (that is, the frequency with which a given word occurs in the training data set). Word frequency may be analyzed by scanning all substrings of bits and directly calculating the frequency of each substring by iterating over the data set to produce an occurrence frequency, which may then be used to estimate the rate of word occurrence in non-training data. A first Huffman binary tree is created based on the frequency of occurrences of each word in the first dataset, and a Huffman codeword is assigned to each observed word in the first dataset according to the first Huffman binary tree. Machine learning may be utilized to improve results by processing a number of training data sets and using the results of each training set to refine the frequency estimations for non-training data, so that the estimation yield better results when used with real-world data (rather than, for example, being only based on a single training data set that may not be very similar to a received non-training data set). A second Huffman tree creator 1303 may be utilized to identify words that do not match any existing entries in a word library 1201 and pass them to a hybrid encoder/decoder 1304, that then calculates a binary Huffman codeword for the mismatched word and adds the codeword and original data to the word library 1201 as a new key-value pair. In this manner, customized library generator 1300 may be used both to establish an initial word library 1201 from a first training set, as well as expand the word library 1201 using additional training data to improve operation.

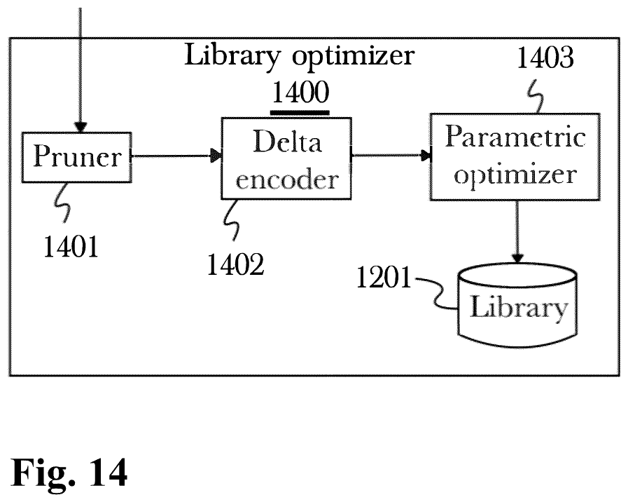

FIG. 14 is a diagram showing a more detailed architecture for a library optimizer 1400. A pruner 1401 may be used to load a word library 1201 and reduce its size for efficient operation, for example by sorting the word library 1201 based on the known occurrence probability of each key-value pair and removing low-probability key-value pairs based on a loaded threshold parameter. This prunes low-value data from the word library to trim the size, eliminating large quantities of very-low-frequency key-value pairs such as single-occurrence words that are unlikely to be encountered again in a data set. Pruning eliminates the least-probable entries from word library 1201 up to a given threshold, which will have a negligible impact on the deflation factor since the removed entries are only the least-common ones, while the impact on word library size will be larger because samples drawn from asymptotically normal distributions (such as the log-probabilities of words generated by a probabilistic finite state machine, a model well-suited to a wide variety of real-world data) which occur in tails of the distribution are disproportionately large in counting measure. A delta encoder 1402 may be utilized to apply delta encoding to a plurality of words to store an approximate codeword as a value in the word library, for which each of the plurality of source words is a valid corresponding key. This may be used to reduce library size by replacing numerous key-value pairs with a single entry for the approximate codeword and then represent actual codewords using the approximate codeword plus a delta value representing the difference between the approximate codeword and the actual codeword. Approximate coding is optimized for low-weight sources such as Golomb coding, run-length coding, and similar techniques. The approximate source words may be chosen by locality-sensitive hashing, so as to approximate Hamming distance without incurring the intractability of nearest-neighbor-search in Hamming space. A parametric optimizer 1403 may load configuration parameters for operation to optimize the use of the word library 1201 during operation. Best-practice parameter/hyperparameter optimization strategies such as stochastic gradient descent, quasi-random grid search, and evolutionary search may be used to make optimal choices for all interdependent settings playing a role in the functionality of system 1200. In cases where lossless compression is not required, the delta value may be discarded at the expense of introducing some limited errors into any decoded (reconstructed) data.

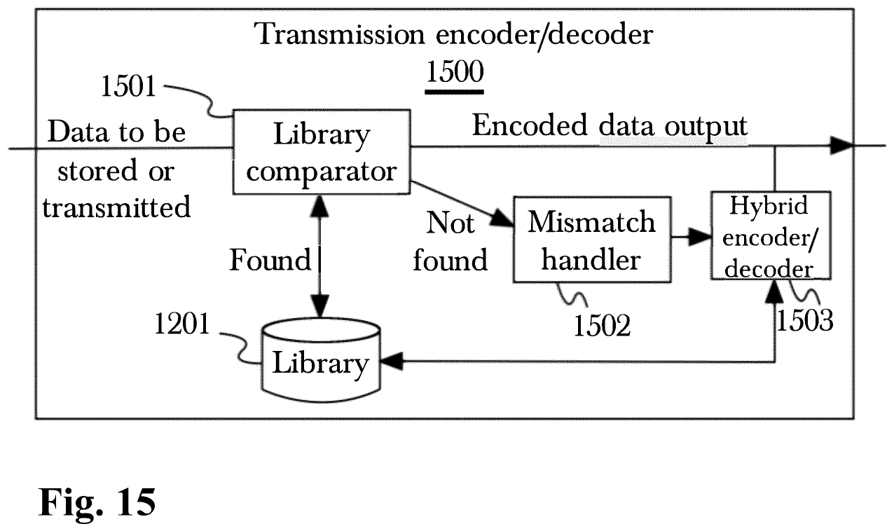

FIG. 15 is a diagram showing a more detailed architecture for a transmission encoder/decoder 1500. According to various arrangements, transmission encoder/decoder 1500 may be used to deconstruct data for storage or transmission, or to reconstruct data that has been received, using a word library 1201. A library comparator 1501 may be used to receive data comprising words or codewords, and compare against a word library 1201 by dividing the incoming stream into substrings of length/and using a fast hash to check word library 1201 for each substring. If a substring is found in word library 1201, the corresponding key/value (that is, the corresponding source word or codeword, according to whether the substring used in comparison was itself a word or codeword) is returned and appended to an output stream. If a given substring is not found in word library 1201, a mismatch handler 1502 and hybrid encoder/decoder 1503 may be used to handle the mismatch similarly to operation during the construction or expansion of word library 1201. A mismatch handler 1502 may be utilized to identify words that do not match any existing entries in a word library 1201 and pass them to a hybrid encoder/decoder 1503, that then calculates a binary Huffman codeword for the mismatched word and adds the codeword and original data to the word library 1201 as a new key-value pair. The newly-produced codeword may then be appended to the output stream. In arrangements where a mismatch indicator is included in a received data stream, this may be used to preemptively identify a substring that is not in word library 1201 (for example, if it was identified as a mismatch on the transmission end), and handled accordingly without the need for a library lookup.

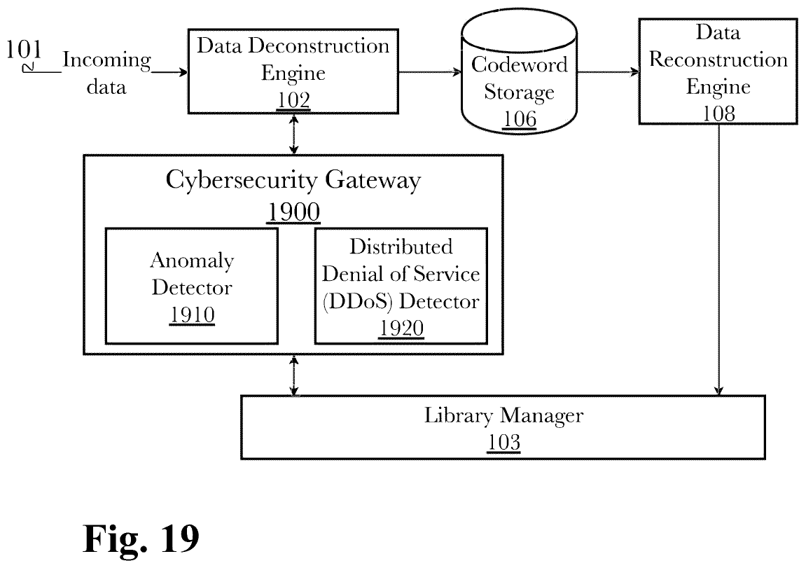

FIG. 19 is an exemplary system architecture of a data encoding system used for cyber security purposes. Much like in FIG. 1, incoming data 101 to be deconstructed is sent to a data deconstruction engine 102, which may attempt to deconstruct the data and turn it into a collection of codewords using a library manager 103. Codeword storage 106 serves to store unique codewords from this process, and may be queried by a data reconstruction engine 108 which may reconstruct the original data from the codewords, using a library manager 103. However, a cybersecurity gateway 1900 is present, communicating in-between a library manager 103 and a deconstruction engine 102, and containing an anomaly detector 1910 and distributed denial of service (DDoS) detector 1920. The anomaly detector examines incoming data to determine whether there is a disproportionate number of incoming reference codes that do not match reference codes in the existing library. A disproportionate number of non-matching reference codes may indicate that data is being received from an unknown source, of an unknown type, or contains unexpected (possibly malicious) data. If the disproportionate number of non-matching reference codes exceeds an established threshold or persists for a certain length of time, the anomaly detector 1910 raises a warning to a system administrator. Likewise, the DDOS detector 1920 examines incoming data to determine whether there is a disproportionate amount of repetitive data. A disproportionate amount of repetitive data may indicate that a DDOS attack is in progress. If the disproportionate amount of repetitive data exceeds an established threshold or persists for a certain length of time, the DDOS detector 1910 raises a warning to a system administrator. In this way, a data encoding system may detect and warn users of, or help mitigate, common cyber-attacks that result from a flow of unexpected and potentially harmful data, or attacks that result from a flow of too much irrelevant data meant to slow down a network or system, as in the case of a DDOS attack.

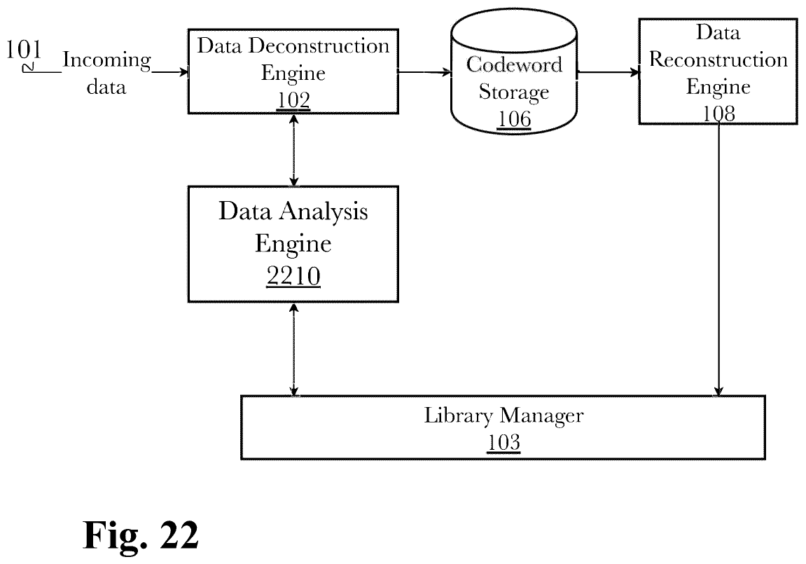

FIG. 22 is an exemplary system architecture of a data encoding system used for data mining and analysis purposes. Much like in FIG. 1, incoming data 101 to be deconstructed is sent to a data deconstruction engine 102, which may attempt to deconstruct the data and turn it into a collection of codewords using a library manager 103. Codeword storage 106 serves to store unique codewords from this process, and may be queried by a data reconstruction engine 108 which may reconstruct the original data from the codewords, using a library manager 103. A data analysis engine 2210, typically operating while the system is otherwise idle, sends requests for data to the data reconstruction engine 108, which retrieves the codewords representing the requested data from codeword storage 106, reconstructs them into the data represented by the codewords, and send the reconstructed data to the data analysis engine 2210 for analysis and extraction of useful data (i.e., data mining). Because the speed of reconstruction is significantly faster than decompression using traditional compression technologies (i.e., significantly less decompression latency), this approach makes data mining feasible. Very often, data stored using traditional compression is not mined precisely because decompression lag makes it unfeasible, especially during shorter periods of system idleness. Increasing the speed of data reconstruction broadens the circumstances under which data mining of stored data is feasible.

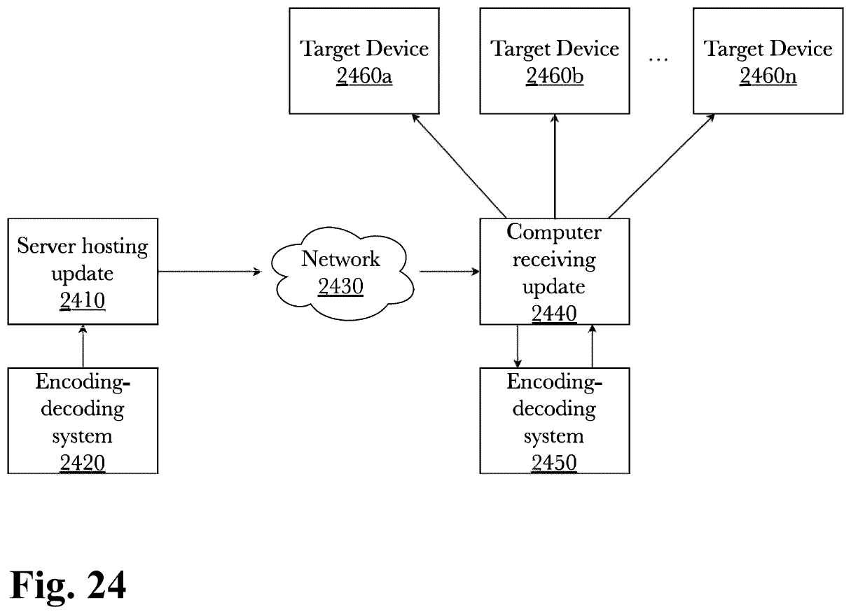

FIG. 24 is an exemplary system architecture of a data encoding system used for remote software and firmware updates. Software and firmware updates typically require smaller, but more frequent, file transfers. A server which hosts a software or firmware update 2410 may host an encoding-decoding system 2420, allowing for data to be encoded into, and decoded from, sourceblocks or codewords, as disclosed in previous figures. Such a server may possess a software update, operating system update, firmware update, device driver update, or any other form of software update, which in some cases may be minor changes to a file, but nevertheless necessitate sending the new, completed file to the recipient. Such a server is connected over a network 2430, which is further connected to a recipient computer 2440, which may be connected to a server 2410 for receiving such an update to its system. In this instance, the recipient device 2440 also hosts the encoding and decoding system 2450, along with a codebook or library of reference codes that the hosting server 2410 also shares. The updates are retrieved from storage at the hosting server 2410 in the form of codewords, transferred over the network 2430 in the form of codewords, and reconstructed on the receiving computer 2440. In this way, a far smaller file size, and smaller total update size, may be sent over a network. The receiving computer 2440 may then install the updates on any number of target computing devices 2460a-n, using a local network or other high-bandwidth connection.

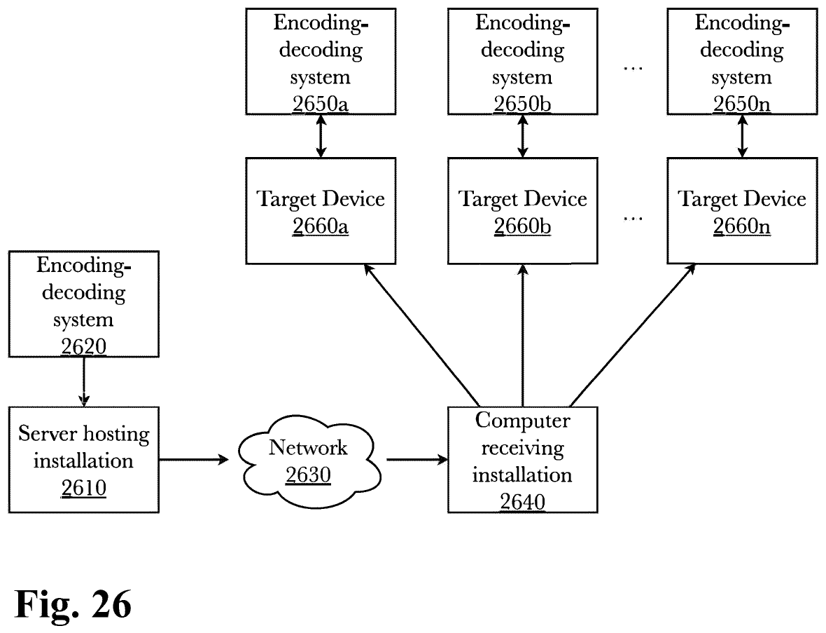

FIG. 26 is an exemplary system architecture of a data encoding system used for large-scale software installation such as operating systems. Large-scale software installations typically require very large, but infrequent, file transfers. A server which hosts an installable software 2610 may host an encoding-decoding system 2620, allowing for data to be encoded into, and decoded from, sourceblocks or codewords, as disclosed in previous figures. The files for the large scale software installation are hosted on the server 2610, which is connected over a network 2630 to a recipient computer 2640. In this instance, the encoding and decoding system 2650a-n is stored on or connected to one or more target devices 2660a-n, along with a codebook or library of reference codes that the hosting server 2610 shares. The software is retrieved from storage at the hosting server 2610 in the form of codewords, and transferred over the network 2630 in the form of codewords to the receiving computer 2640. However, instead of being reconstructed at the receiving computer 2640, the codewords are transmitted to one or more target computing devices, and reconstructed and installed directly on the target devices 2660a-n. In this way, a far smaller file size, and smaller total update size, may be sent over a network or transferred between computing devices, even where the network 2630 between the receiving computer 2640 and target devices 2660a-n is low bandwidth, or where there are many target devices 2660a-n.

FIG. 28 is a diagram showing an exemplary embodiment in which a pre-trained version of the codebook library and associated algorithms would be encoded as firmware on a semiconductor multi-core processing chip 2800 included as part of the hardware of a plurality of devices. According to an embodiment, a semiconductor, such as a multi-core processing chip 2800, may have two or more processing cores 2801, 2806 which may pass data between and among the cores using a data bus 2809. As more and more processors are used to perform tasks, larger portion of the resources and cost is used to transport bits between processors. This cost is proportional to the number of bits/second that need to be transported. The cost is high for data transport between processor components where the data travels across circuit board traces. In order to reduce the cost of intra-chip (on-chip) data transportation between processing cores, a pre-trained codebook 2803 and algorithms 2804, which are lightweight code, may be embedded or programmed into firmware 2802, 2807 in a semiconductor. The system works by using training data to identify patterns in data prior to embedding code or programming firmware in a semiconductor. These patterns and their associated, smaller indices, or codewords, are stored in a codebook 2803 that is replicated on both the sending and receiving bus, along with lightweight code comprising the deconstruction and reconstruction algorithms 2804. In processing live data, only codewords, much smaller than the original data, are transferred between buses.

Data compaction is a stepless process that operates as fast as the data is created, a key component of the compaction process extreme low latency performance. As source data is generated, it is encoded by the deconstruction algorithm 2804 and the codewords are sent; at the destination (a different core), codewords are decoded via the reconstruction algorithm 2804 and the original data is instantaneously rebuilt, even as the file is still being generated at the source. The computationally intensive tasks of searching for patterns in data is performed in advance of embedding; in live semiconductor operation, the tasks involved consist primarily of lookups (e.g., codebook lookups), which are light and fast. The system and methods of compacting data disclosed may be especially suited to accelerate on-chip communications. Because the system and methods disclosed provide effective data reduction down to the scale of a few bytes and requires very limited instruction complexity to encode or decode, it can be deployed in on-chip computing environments with highly limited resources. There are various cost-saving and performance-enhancing applications when using a chip integrated with the disclosed system and method. First, it may help reduce bandwidth use of data buses/interconnects: by encoding data, the chip components send fewer bits, implying lower power demands, lower interconnect bandwidth/multiplexing requirements, and fast overall transmissions. Second, it may ameliorate data routing congestion: by increasing the information density of messages or packets in network-on-chip contexts, the delays and pile-ups due to buffer congestion at on-chip routers can be substantially reduced, improving overall communications speed. Third, it may improve efficiency of memory resources: by compacting data that is being temporarily store during computation (e.g., registers, scratchpad, cache, etc.) the disclosed system and methods can pack more data into available on-chip memory and require fewer allocations, maker fewer accesses, and cause fewer misses. Furthermore, it may improve attenuation of crosstalk between components and interconnects/busses: the system integrated onto a chip may even be able to help with capacitive and inductive crosstalk by increasing the entropy rate of signals being transmitted on interconnection wires, thus decreasing periodicity and other patterns that contribute to coupling behavior. This use has the potential to enable denser wiring and more components per unit area.

According to an embodiment, contained on the multi-core chip 2800 for each core 2801, 2806 would be a firmware area 2802, 2807, on which would be a stored a copy of a pre-trained codebook 2803 and deconstruction/reconstruction algorithms 2804 for processing data. Processors 2805, 2808 would have both inputs and outputs to other hardware on the device. Processors 2805, 2808 would store incoming data for processing on on-chip memory 2810, process the data using the pre-trained codebook 2803 and deconstruction/reconstruction algorithms 2804, and the send the processed data to other hardware (e.g., another core) on the device. Any device equipped with this embodiment would be able to store and transmit data in a highly optimized, bandwidth-efficient format with any other device equipped with this embodiment.

FIG. 29 is a diagram showing an embodiment in which a pre-trained version of the codebook library and associated algorithms would be encoded as firmware on an exemplary multi-chip module 2900 included as part of the hardware of a plurality of devices. A multi-chip module is generally designed by putting multiple processor semiconductor die (i.e., chips) inside very small packages. This means that processor-to-processor communication is more expensive than if all processors are on the same die. In order to reduce the cost of chip-to-chip data transportation between processing chips, a pre-trained codebook 2912 and algorithms 2913, which are lightweight code, may be embedded or programmed into firmware 2911, 2921 in a semiconductor. The system works by using training data to identify patterns in data prior to embedding code or programming firmware in a semiconductor. These patterns and their associated, smaller indices, or codewords, are stored in a codebook 2912 that is replicated on both the sending and receiving bus, along with lightweight code comprising the deconstruction and reconstruction algorithms 2913. In processing live data, only codewords, much smaller than the original data, are transferred between buses. If each processor were to encode and compact the data it receives and sends using the system and methods disclosed, then the multi-chip module components would send fewer bits, which may lead to lower power demands, lower interconnect bandwidth/multiplexing requirements, and faster overall transmissions. According to an embodiment, contained on the multi-chip module 2900 for each chip 2910, 2920 would be a firmware area 2911, 2921, on which would be a stored a copy of a pre-trained codebook 2912 and deconstruction/reconstruction algorithms 2913 for processing data. Processors 2914, 2922 would have both inputs and outputs to other hardware on the device. Processors 2914, 2922 would store incoming data for processing on on-chip memory 2915, 2923, process the data using the pre-trained codebook 2912 and deconstruction/reconstruction algorithms 2913, and then send the processed data to other hardware (e.g., another chip via a bus 2930) on the device. Any device equipped with this embodiment would be able to store and transmit data in a highly optimized, bandwidth-efficient format with any other device equipped with this embodiment.

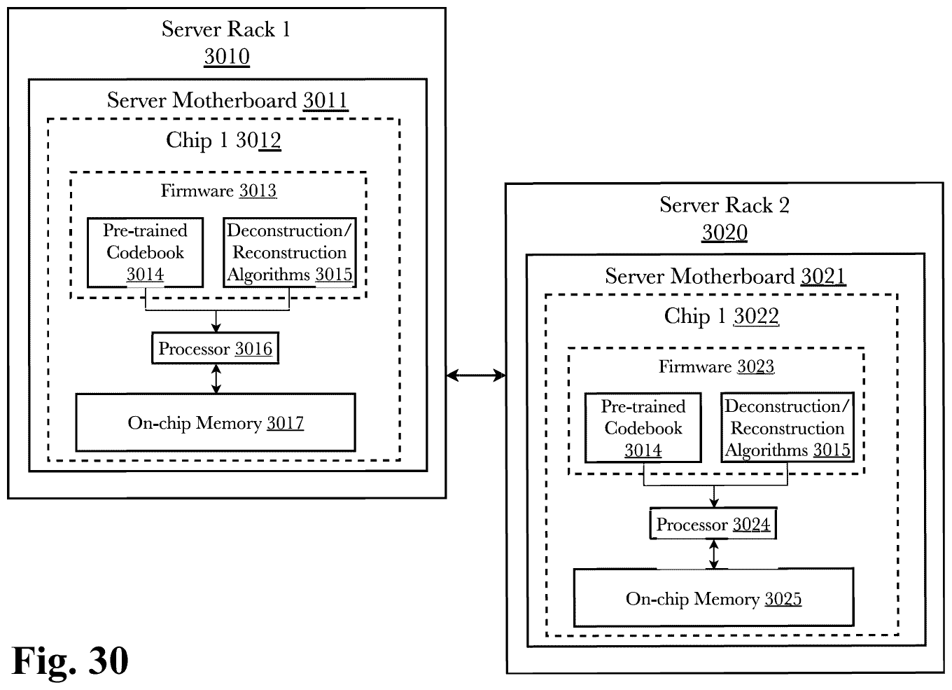

FIG. 30 is a diagram showing an embodiment in which a pre-trained version of the codebook library and associated algorithms would be encoded as firmware on an exemplary server motherboard 3011, 3021 operating within a server rack 3010, 3020. Enterprises or facilities that handle (e.g., receive, transmit, intercept, obtain, generate, process, etc.) large volumes of data, such as a data center, often utilize one or more servers for processing and routing data and requests. Transporting data between different boards contained within a single server rack, or from one rack to another increases the resources and cost of moving bits between the processors housed in the boards. In order to reduce the cost of intra-data center data transportation between board-to-board or rack-to-rack, a pre-trained codebook 3014 and algorithms 3015, which are lightweight code, may be embedded or programmed into firmware 3013, 3023 in a semiconductor located on the server motherboards 3011, 3021. The system works by using training data to identify patterns in data prior to embedding code or programming firmware in a semiconductor. These patterns and their associated, smaller indices, or codewords, are stored in a codebook 3014 that is replicated on both the sending and receiving bus, along with lightweight code comprising the deconstruction and reconstruction algorithms 3015. In processing live data, only codewords, much smaller than the original data, are transferred between buses. If each processor were to encode and compact the data it receives and sends using the system and methods disclosed, then the server components would send fewer bits, which may lead to lower power demands, lower interconnect bandwidth/multiplexing requirements, and faster overall transmissions.

According to an embodiment, contained on a server motherboard 3011, 3021 for each chip 3012, 3022 would be a firmware area 3013, 3023, on which would be a stored a copy of a pre-trained codebook 3014 and deconstruction/reconstruction algorithms 3015 for processing data. Processors 3016, 3024 would have both inputs and outputs to other hardware on the board 3011. Processors 3016, 3024 would store incoming data for processing on on-chip memory 3017, 3025, process the data using the pre-trained codebook 3014 and deconstruction/reconstruction algorithms 3015, and then send the processed data to other hardware (e.g., another chip on board, another board in rack, another rack). Any device equipped with this embodiment would be able to store and transmit data in a highly optimized, bandwidth-efficient format with any other device equipped with this embodiment.

### Description of Method Aspects

Since the library consists of re-usable building sourceblocks, and the actual data is represented by reference codes to the library, the total storage space of a single set of data would be much smaller than conventional methods, wherein the data is stored in its entirety. The more data sets that are stored, the larger the library becomes, and the more data can be stored in reference code form.

As an analogy, imagine each data set as a collection of printed books that are only occasionally accessed. The amount of physical shelf space required to store many collections would be quite large, and is analogous to conventional methods of storing every single bit of data in every data set. Consider, however, storing all common elements within and across books in a single library, and storing the books as references codes to those common elements in that library. As a single book is added to the library, it will contain many repetitions of words and phrases. Instead of storing the whole words and phrases, they are added to a library, and given a reference code, and stored as reference codes. At this scale, some space savings may be achieved, but the reference codes will be on the order of the same size as the words themselves. As more books are added to the library, larger phrases, quotations, and other words patterns will become common among the books. The larger the word patterns, the smaller the reference codes will be in relation to them as not all possible word patterns will be used. As entire collections of books are added to the library, sentences, paragraphs, pages, or even whole books will become repetitive. There may be many duplicates of books within a collection and across multiple collections, many references and quotations from one book to another, and much common phraseology within books on particular subjects. If each unique page of a book is stored only once in a common library and given a reference code, then a book of 1,000 pages or more could be stored on a few printed pages as a string of codes referencing the proper full-sized pages in the common library. The physical space taken up by the books would be dramatically reduced. The more collections that are added, the greater the likelihood that phrases, paragraphs, pages, or entire books will already be in the library, and the more information in each collection of books can be stored in reference form. Accessing entire collections of books is then limited not by physical shelf space, but by the ability to reprint and recycle the books as needed for use.

The projected increase in storage capacity using the method herein described is primarily dependent on two factors: 1) the ratio of the number of bits in a block to the number of bits in the reference code, and 2) the amount of repetition in data being stored by the system.

With respect to the first factor, the number of bits used in the reference codes to the sourceblocks must be smaller than the number of bits in the sourceblocks themselves in order for any additional data storage capacity to be obtained. As a simple example, 16-bit sourceblocks would require 2¹⁶, or 65536, unique reference codes to represent all possible patterns of bits. If all possible 65536 blocks patterns are utilized, then the reference code itself would also need to contain sixteen bits in order to refer to all possible 65,536 blocks patterns. In such case, there would be no storage savings. However, if only 16 of those block patterns are utilized, the reference code can be reduced to 4 bits in size, representing an effective compression of 4 times (16 bits/4 bits=4) versus conventional storage. Using a typical block size of 512 bytes, or 4,096 bits, the number of possible block patterns is 2^{4,096}, which for all practical purposes is unlimited. A typical hard drive contains one terabyte (TB) of physical storage capacity, which represents 1,953,125,000, or roughly 2³¹, 512 byte blocks. Assuming that 1 TB of unique 512-byte sourceblocks were contained in the library, and that the reference code would thus need to be 31 bits long, the effective compression ratio for stored data would be on the order of 132 times (4,096/31≈132) that of conventional storage.

With respect to the second factor, in most cases it could be assumed that there would be sufficient repetition within a data set such that, when the data set is broken down into sourceblocks, its size within the library would be smaller than the original data. However, it is conceivable that the initial copy of a data set could require somewhat more storage space than the data stored in a conventional manner, if all or nearly all sourceblocks in that set were unique. For example, assuming that the reference codes are 1/10^{th} the size of a full-sized copy, the first copy stored as sourceblocks in the library would need to be 1.1 megabytes (MB), (1 MB for the complete set of full-sized sourceblocks in the library and 0.1 MB for the reference codes). However, since the sourceblocks stored in the library are universal, the more duplicate copies of something you save, the greater efficiency versus conventional storage methods. Conventionally, storing 10 copies of the same data requires 10 times the storage space of a single copy. For example, ten copies of a 1 MB file would take up 10 MB of storage space. However, using the method described herein, only a single full-sized copy is stored, and subsequent copies are stored as reference codes. Each additional copy takes up only a fraction of the space of the full-sized copy. For example, again assuming that the reference codes are 1/10^{th} the size of the full-size copy, ten copies of a 1 MB file would take up only 2 MB of space (1 MB for the full-sized copy, and 0.1 MB each for ten sets of reference codes). The larger the library, the more likely that part or all of incoming data will duplicate sourceblocks already existing in the library.

The size of the library could be reduced in a manner similar to storage of data. Where sourceblocks differ from each other only by a certain number of bits, instead of storing a new sourceblock that is very similar to one already existing in the library, the new sourceblock could be represented as a reference code to the existing sourceblock, plus information about which bits in the new block differ from the existing block. For example, in the case where 512 byte sourceblocks are being used, if the system receives a new sourceblock that differs by only one bit from a sourceblock already existing in the library, instead of storing a new 512 byte sourceblock, the new sourceblock could be stored as a reference code to the existing sourceblock, plus a reference to the bit that differs. Storing the new sourceblock as a reference code plus changes would require only a few bytes of physical storage space versus the 512 bytes that a full sourceblock would require. The algorithm could be optimized to store new sourceblocks in this reference code plus changes form unless the changes portion is large enough that it is more efficient to store a new, full sourceblock.

It will be understood by one skilled in the art that transfer and synchronization of data would be increased to the same extent as for storage. By transferring or synchronizing reference codes instead of full-sized data, the bandwidth requirements for both types of operations are dramatically reduced.

In addition, the method described herein is inherently a form of encryption. When the data is converted from its full form to reference codes, none of the original data is contained in the reference codes. Without access to the library of sourceblocks, it would be impossible to re-construct any portion of the data from the reference codes. This inherent property of the method described herein could obviate the need for traditional encryption algorithms, thereby offsetting most or all of the computational cost of conversion of data back and forth to reference codes. In theory, the method described herein should not utilize any additional computing power beyond traditional storage using encryption algorithms. Alternatively, the method described herein could be in addition to other encryption algorithms to increase data security even further.

In other embodiments, additional security features could be added, such as: creating a proprietary library of sourceblocks for proprietary networks, physical separation of the reference codes from the library of sourceblocks, storage of the library of sourceblocks on a removable device to enable easy physical separation of the library and reference codes from any network, and incorporation of proprietary sequences of how sourceblocks are read and the data reassembled.

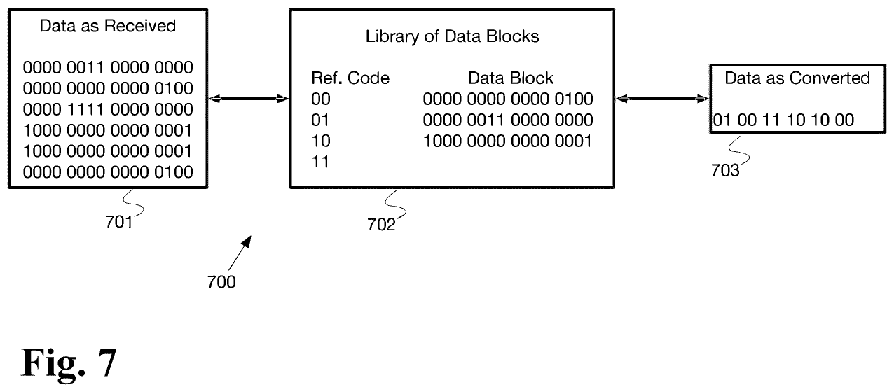

FIG. 7 is a diagram showing an example of how data might be converted into reference codes using an aspect of an embodiment 700. As data is received 701, it is read by the processor in sourceblocks of a size dynamically determined by the previously disclosed sourceblock size optimizer 410. In this example, each sourceblock is 16 bits in length, and the library 702 initially contains three sourceblocks with reference codes 00, 01, and 10. The entry for reference code 11 is initially empty. As each 16 bit sourceblock is received, it is compared with the library. If that sourceblock is already contained in the library, it is assigned the corresponding reference code. So, for example, as the first line of data (0000 0011 0000 0000) is received, it is assigned the reference code (01) associated with that sourceblock in the library. If that sourceblock is not already contained in the library, as is the case with the third line of data (0000 1111 0000 0000) received in the example, that sourceblock is added to the library and assigned a reference code, in this case 11. The data is thus converted 703 to a series of reference codes to sourceblocks in the library. The data is stored as a collection of codewords, each of which contains the reference code to a sourceblock and information about the location of the sourceblocks in the data set. Reconstructing the data is performed by reversing the process. Each stored reference code in a data collection is compared with the reference codes in the library, the corresponding sourceblock is read from the library, and the data is reconstructed into its original form.

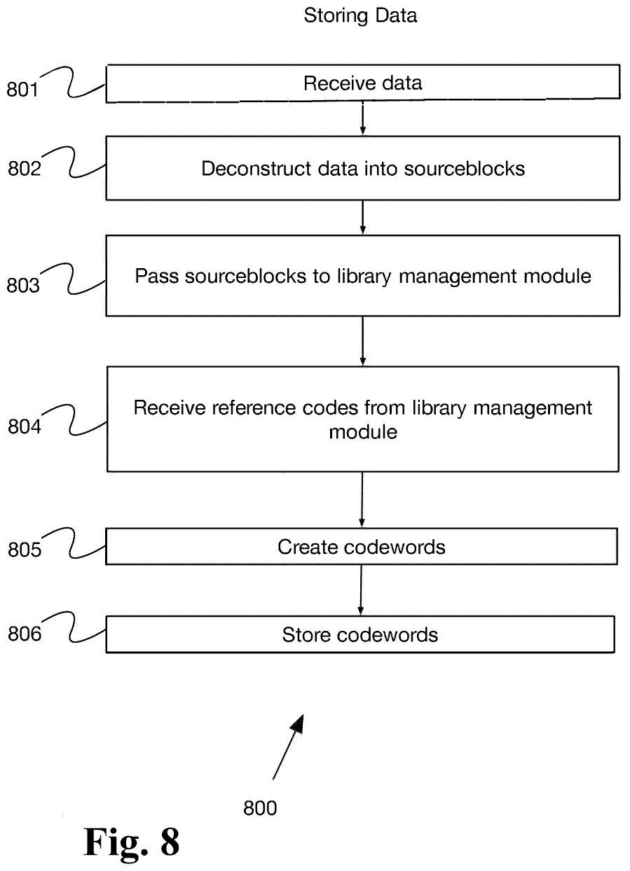

FIG. 8 is a method diagram showing the steps involved in using an embodiment 800 to store data. As data is received 801, it would be deconstructed into sourceblocks 802, and passed 803 to the library management module for processing. Reference codes would be received back 804 from the library management module, and could be combined with location information to create codewords 805, which would then be stored 806 as representations of the original data.

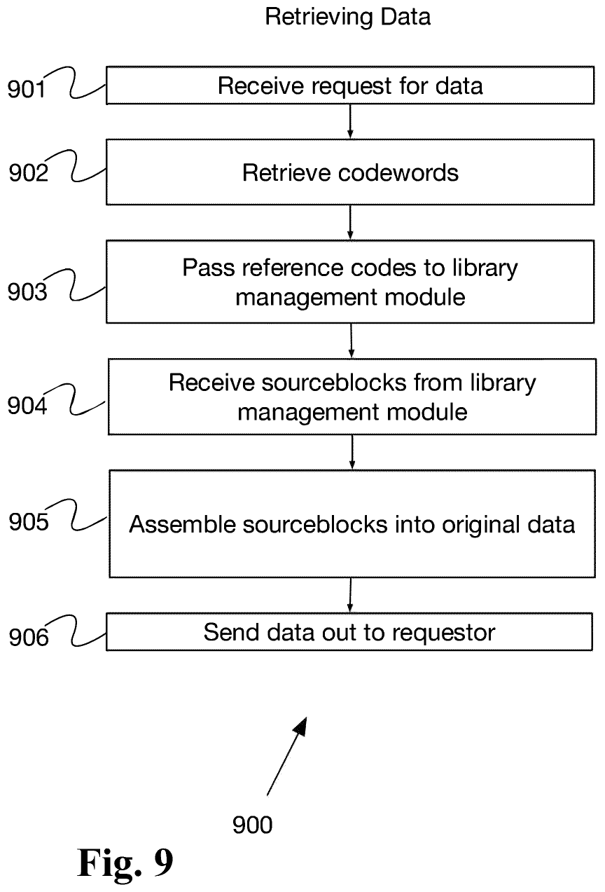

FIG. 9 is a method diagram showing the steps involved in using an embodiment 900 to retrieve data. When a request for data is received 901, the associated codewords would be retrieved 902 from the library. The codewords would be passed 903 to the library management module, and the associated sourceblocks would be received back 904. Upon receipt, the sourceblocks would be assembled 905 into the original data using the location data contained in the codewords, and the reconstructed data would be sent out 906 to the requestor.

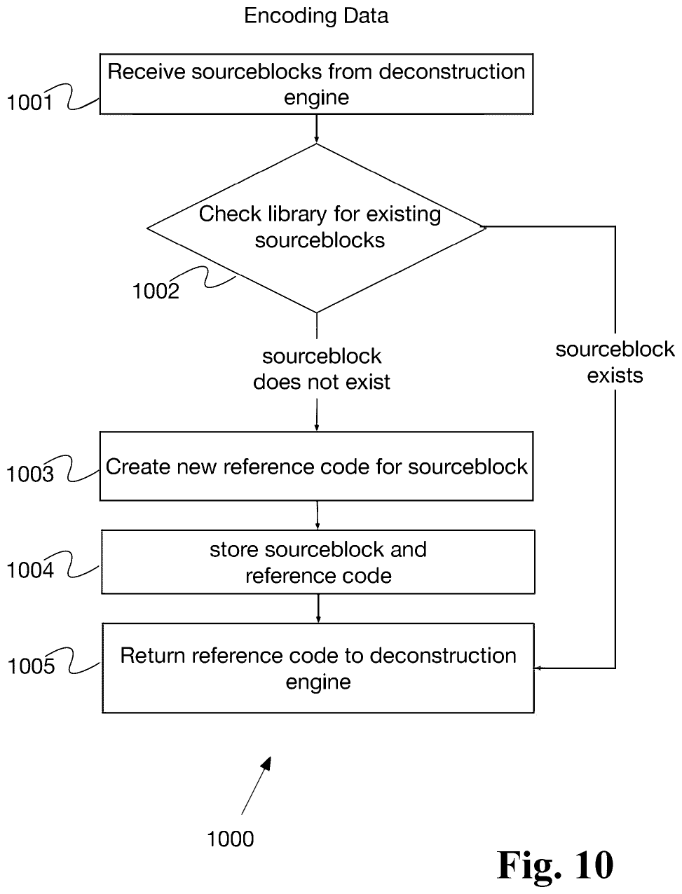

FIG. 10 is a method diagram showing the steps involved in using an embodiment 1000 to encode data. As sourceblocks are received 1001 from the deconstruction engine, they would be compared 1002 with the sourceblocks already contained in the library. If that sourceblock already exists in the library, the associated reference code would be returned 1005 to the deconstruction engine. If the sourceblock does not already exist in the library, a new reference code would be created 1003 for the sourceblock. The new reference code and its associated sourceblock would be stored 1004 in the library, and the reference code would be returned to the deconstruction engine.

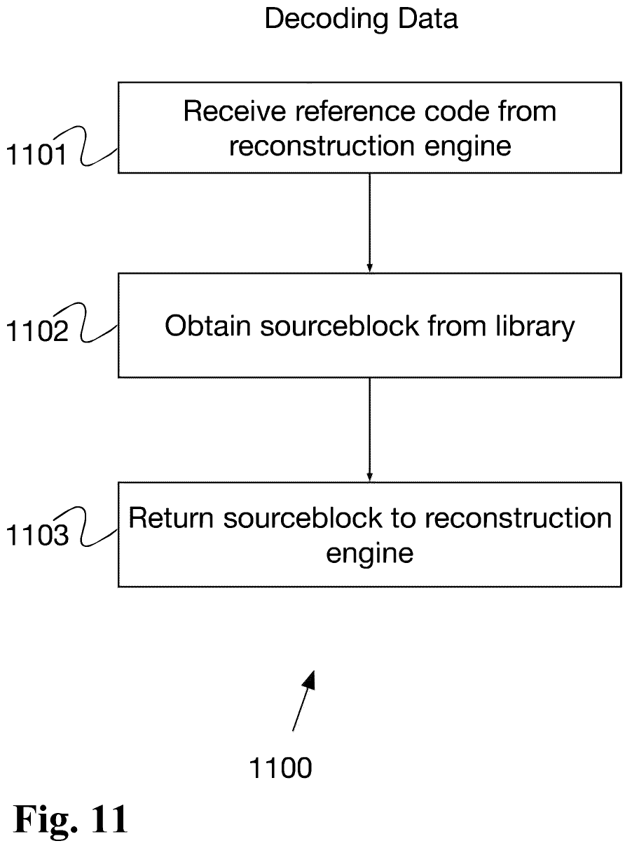

FIG. 11 is a method diagram showing the steps involved in using an embodiment 1100 to decode data. As reference codes are received 1101 from the reconstruction engine, the associated sourceblocks are retrieved 1102 from the library, and returned 1103 to the reconstruction engine.

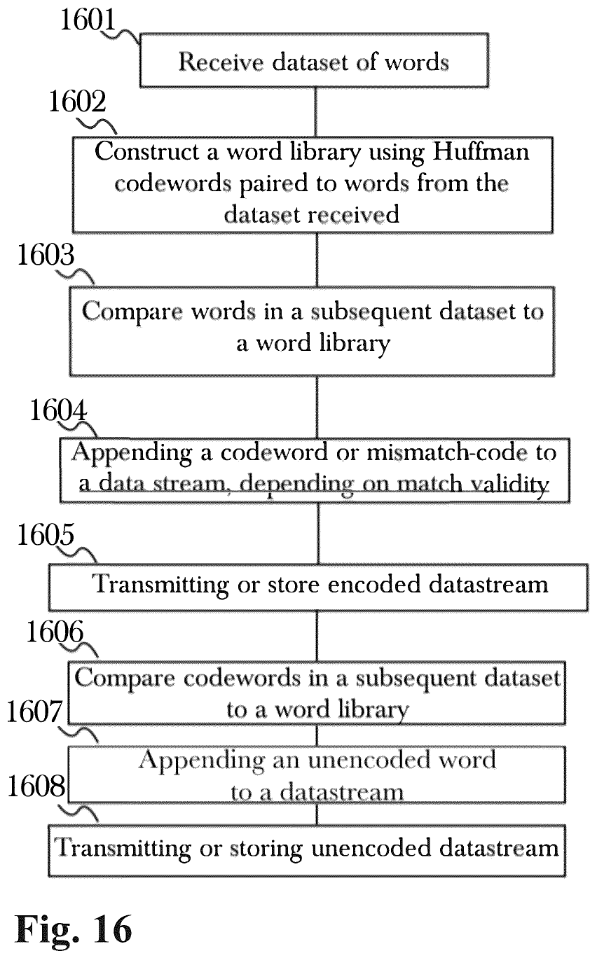

FIG. 16 is a method diagram illustrating key system functionality utilizing an encoder and decoder pair, according to a preferred embodiment. In a first step 1601, at least one incoming data set may be received at a customized library generator 1300 that then 1602 processes data to produce a customized word library 1201 comprising key-value pairs of data words (each comprising a string of bits) and their corresponding calculated binary Huffman codewords. A subsequent dataset may be received, and compared to the word library 1603 to determine the proper codewords to use in order to encode the dataset. Words in the dataset are checked against the word library and appropriate encodings are appended to a data stream 1604. If a word is mismatched within the word library and the dataset, meaning that it is present in the dataset but not the word library, then a mismatched code is appended, followed by the unencoded original word. If a word has a match within the word library, then the appropriate codeword in the word library is appended to the data stream. Such a data stream may then be stored or transmitted 1605 to a destination as desired. For the purposes of decoding, an already-encoded data stream may be received and compared 1606, and un-encoded words may be appended to a new data stream 1607 depending on word matches found between the encoded data stream and the word library that is present. A matching codeword that is found in a word library is replaced with the matching word and appended to a data stream, and a mismatch code found in a data stream is deleted and the following unencoded word is re-appended to a new data stream, the inverse of the process of encoding described earlier. Such a data stream may then be stored or transmitted 1608 as desired.

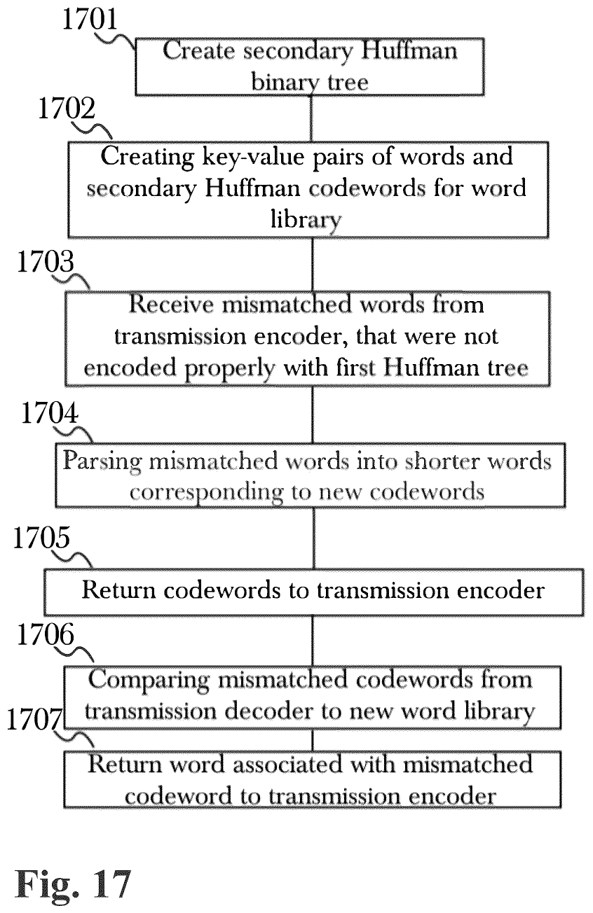

FIG. 17 is a method diagram illustrating possible use of a hybrid encoder/decoder to improve the compression ratio, according to a preferred aspect. A second Huffman binary tree may be created 1701, having a shorter maximum length of codewords than a first Huffman binary tree 1602, allowing a word library to be filled with every combination of codeword possible in this shorter Huffman binary tree 1702. A word library may be filled with these Huffman codewords and words from a dataset 1702, such that a hybrid encoder/decoder 1304, 1503 may receive any mismatched words from a dataset for which encoding has been attempted with a first Huffman binary tree 1703, 1604 and parse previously mismatched words into new partial codewords (that is, codewords that are each a substring of an original mismatched codeword) using the second Huffman binary tree 1704. In this way, an incomplete word library may be supplemented by a second word library. New codewords attained in this way may then be returned to a transmission encoder 1705, 1500. In the event that an encoded dataset is received for decoding, and there is a mismatch code indicating that additional coding is needed, a mismatch code may be removed and the unencoded word used to generate a new codeword as before 1706, so that a transmission encoder 1500 may have the word and newly generated codeword added to its word library 1707, to prevent further mismatching and errors in encoding and decoding.

It will be recognized by a person skilled in the art that the methods described herein can be applied to data in any form. For example, the method described herein could be used to store genetic data, which has four data units: C, G, A, and T. Those four data units can be represented as 2 bit sequences: 00, 01, 10, and 11, which can be processed and stored using the method described herein.

It will be recognized by a person skilled in the art that certain embodiments of the methods described herein may have uses other than data storage. For example, because the data is stored in reference code form, it cannot be reconstructed without the availability of the library of sourceblocks. This is effectively a form of encryption, which could be used for cyber security purposes. As another example, an embodiment of the method described herein could be used to store backup copies of data, provide for redundancy in the event of server failure, or provide additional security against cyberattacks by distributing multiple partial copies of the library among computers are various locations, ensuring that at least two copies of each sourceblock exist in different locations within the network.

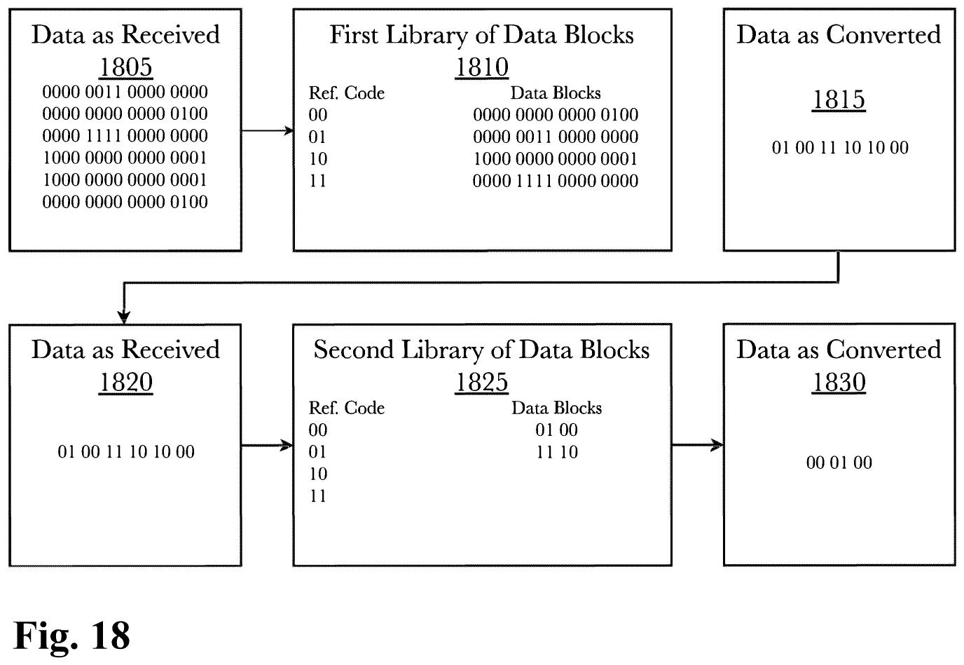

FIG. 18 is a flow diagram illustrating the use of a data encoding system used to recursively encode data to further reduce data size. Data may be input 1805 into a data deconstruction engine 102 to be deconstructed into code references, using a library of code references based on the input 1810. Such example data is shown in a converted, encoded format 1815, highly compressed, reducing the example data from 96 bits of data to 12 bits of data, before sending this newly encoded data through the process again 1820, to be encoded by a second library 1825, reducing it even further. The newly converted data 1830 is shown as only 6 bits in this example, thus a size of 6.25% of the original data packet. With recursive encoding, then, it is possible and implemented in the system to achieve increasing compression ratios, using multi-layered encoding, through recursively encoding data. Both initial encoding libraries 1810 and subsequent libraries 1825 may be achieved through machine learning techniques to find optimal encoding patterns to reduce size, with the libraries being distributed to recipients prior to transfer of the actual encoded data, such that only the compressed data 1830 must be transferred or stored, allowing for smaller data footprints and bandwidth requirements. This process can be reversed to reconstruct the data. While this example shows only two levels of encoding, recursive encoding may be repeated any number of times. The number of levels of recursive encoding will depend on many factors, a non-exhaustive list of which includes the type of data being encoded, the size of the original data, the intended usage of the data, the number of instances of data being stored, and available storage space for codebooks and libraries. Additionally, recursive encoding can be applied not only to data to be stored or transmitted, but also to the codebooks and/or libraries, themselves. For example, many installations of different libraries could take up a substantial amount of storage space. Recursively encoding those different libraries to a single, universal library would dramatically reduce the amount of storage space required, and each different library could be reconstructed as necessary to reconstruct incoming streams of data.

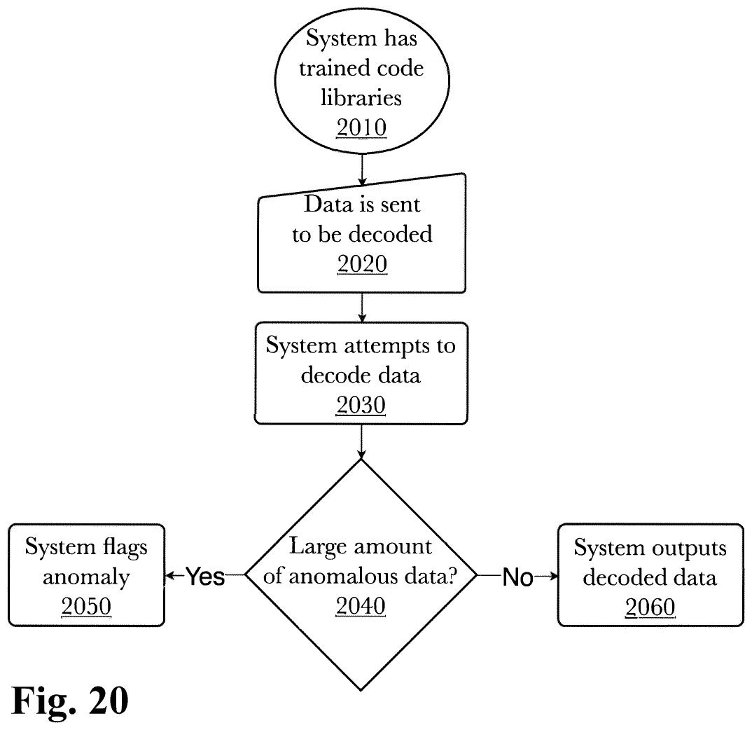

FIG. 20 is a flow diagram of an exemplary method used to detect anomalies in received encoded data and producing a warning. A system may have trained encoding libraries 2010, before data is received from some source such as a network connected device or a locally connected device including USB connected devices, to be decoded 2020. Decoding in this context refers to the process of using the encoding libraries to take the received data and attempt to use encoded references to decode the data into its original source 2030, potentially more than once if recursive encoding was used, but not necessarily more than once. An anomaly detector 1910 may be configured to detect a large amount of un-encoded data 2040 in the midst of encoded data, by locating data or references that do not appear in the encoding libraries, indicating at least an anomaly, and potentially data tampering or faulty encoding libraries. A flag or warning is set by the system 2050, allowing a user to be warned at least of the presence of the anomaly and the characteristics of the anomaly. However, if a large amount of invalid references or unencoded data are not present in the encoded data that is attempting to be decoded, the data may be decoded and output as normal 2060, indicating no anomaly has been detected.

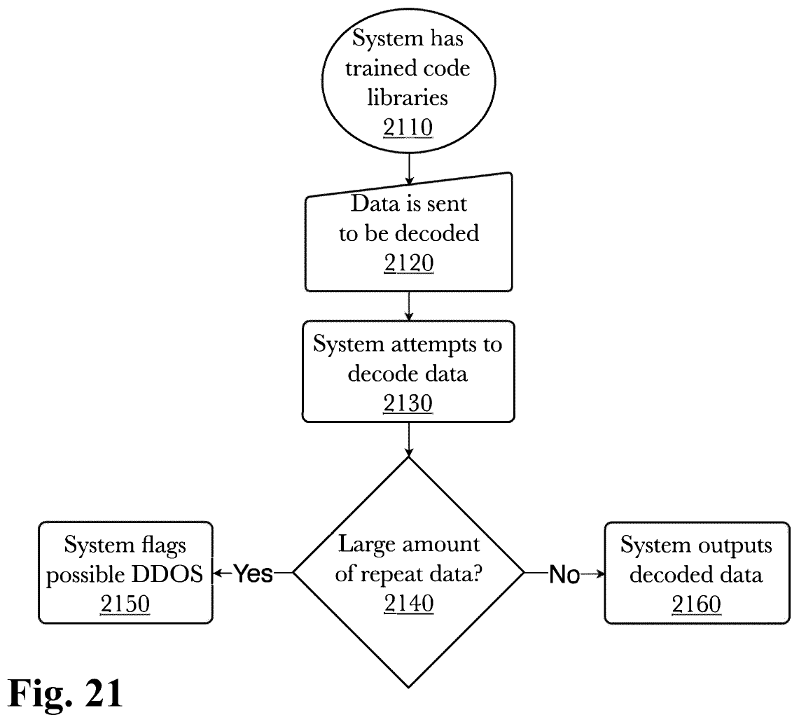

FIG. 21 is a flow diagram of a method used for Distributed Denial of Service (DDoS) attack denial. A system may have trained encoding libraries 2110, before data is received from some source such as a network connected device or a locally connected device including USB connected devices, to be decoded 2120. Decoding in this context refers to the process of using the encoding libraries to take the received data and attempt to use encoded references to decode the data into its original source 2130, potentially more than once if recursive encoding was used, but not necessarily more than once. A DDOS detector 1920 may be configured to detect a large amount of repeating data 2140 in the encoded data, by locating data or references that repeat many times over (the number of which can be configured by a user or administrator as need be), indicating a possible DDOS attack. A flag or warning is set by the system 2150, allowing a user to be warned at least of the presence of a possible DDOS attack, including characteristics about the data and source that initiated the flag, allowing a user to then block incoming data from that source. However, if a large amount of repeat data in a short span of time is not detected, the data may be decoded and output as normal 2160, indicating no DDOS attack has been detected.

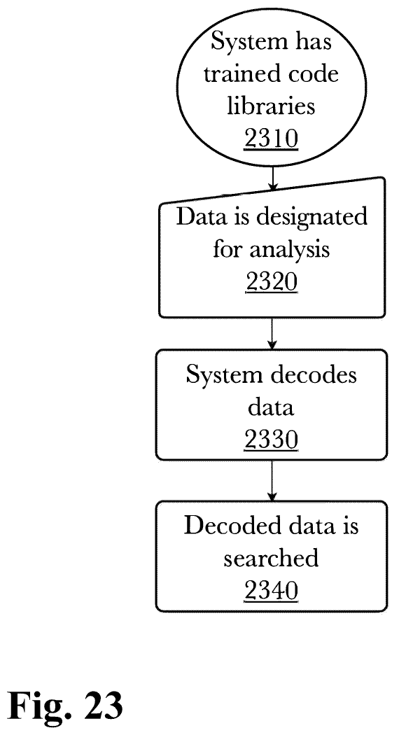

FIG. 23 is a flow diagram of an exemplary method used to enable high-speed data mining of repetitive data. A system may have trained encoding libraries 2310, before data is received from some source such as a network connected device or a locally connected device including USB connected devices, to be analyzed 2320 and decoded 2330. When determining data for analysis, users may select specific data to designate for decoding 2330, before running any data mining or analytics functions or software on the decoded data 2340. Rather than having traditional decryption and decompression operate over distributed drives, data can be regenerated immediately using the encoding libraries disclosed herein, as it is being searched. Using methods described in FIG. 9 and FIG. 11, data can be stored, retrieved, and decoded swiftly for searching, even across multiple devices, because the encoding library may be on each device. For example, if a group of servers host codewords relevant for data mining purposes, a single computer can request these codewords, and the codewords can be sent to the recipient swiftly over the bandwidth of their connection, allowing the recipient to locally decode the data for immediate evaluation and searching, rather than running slow, traditional decompression algorithms on data stored across multiple devices or transfer larger sums of data across limited bandwidth.

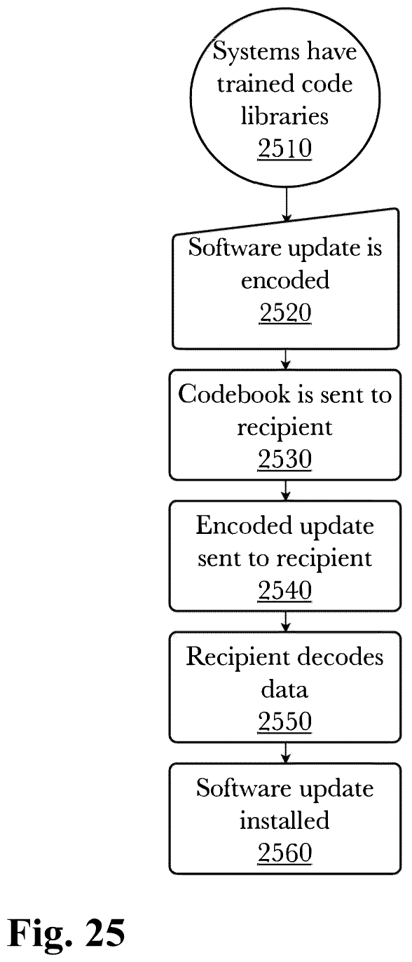

FIG. 25 is a flow diagram of an exemplary method used to encode and transfer software and firmware updates to a device for installation, for the purposes of reduced bandwidth consumption. A first system may have trained code libraries or “codebooks” present 2510, allowing for a software update of some manner to be encoded 2520. Such a software update may be a firmware update, operating system update, security patch, application patch or upgrade, or any other type of software update, patch, modification, or upgrade, affecting any computer system. A codebook for the patch must be distributed to a recipient 2530, which may be done beforehand and either over a network or through a local or physical connection, but must be accomplished at some point in the process before the update may be installed on the recipient device 2560. An update may then be distributed to a recipient device 2540, allowing a recipient with a codebook distributed to them 2530 to decode the update 2550 before installation 2560. In this way, an encoded and thus heavily compressed update may be sent to a recipient far quicker and with less bandwidth usage than traditional lossless compression methods for data, or when sending data in uncompressed formats. This especially may benefit large distributions of software and software updates, as with enterprises updating large numbers of devices at once.

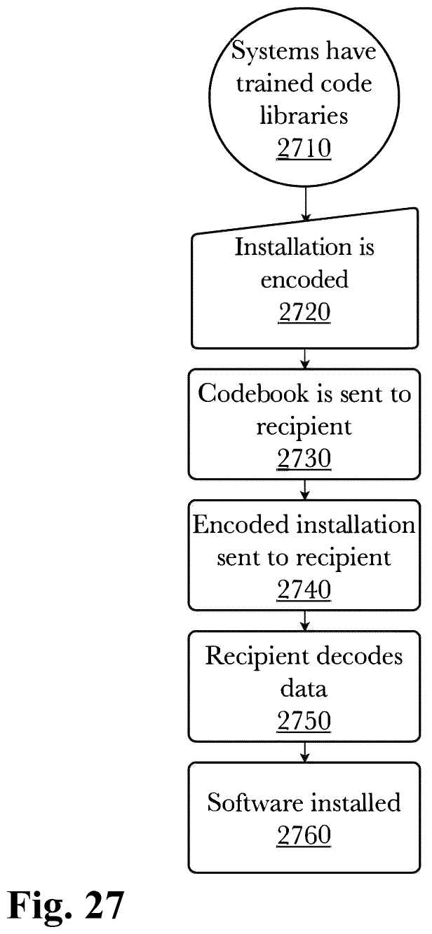

FIG. 27 is a flow diagram of an exemplary method used to encode new software and operating system installations for reduced bandwidth required for transference. A first system may have trained code libraries or “codebooks” present 2710, allowing for a software installation of some manner to be encoded 2720. Such a software installation may be a software update, operating system, security system, application, or any other type of software installation, execution, or acquisition, affecting a computer system. An encoding library or “codebook” for the installation must be distributed to a recipient 2730, which may be done beforehand and either over a network or through a local or physical connection, but must be accomplished at some point in the process before the installation can begin on the recipient device 2760. An installation may then be distributed to a recipient device 2740, allowing a recipient with a codebook distributed to them 2730 to decode the installation 2750 before executing the installation 2760. In this way, an encoded and thus heavily compressed software installation may be sent to a recipient far quicker and with less bandwidth usage than traditional lossless compression methods for data, or when sending data in uncompressed formats. This especially may benefit large distributions of software and software updates, as with enterprises updating large numbers of devices at once.

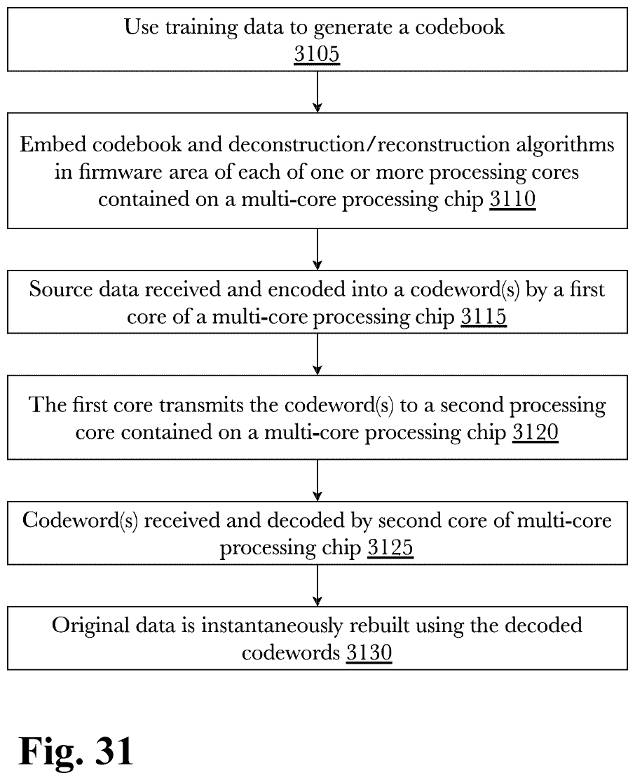

FIG. 31 is a flow diagram of an exemplary method used to transmit encoded data between one or more processing cores of a multi-core processing chip for increased bandwidth required for transmittance. According to an embodiment, the use of training data to generate a codebook 3105 is the first step taken. The training data is used to identify patterns in data prior to embedding code or programming firmware in a semiconductor (e.g., a processing chip with one or more processing cores). These patterns and their associated, smaller indices, or codewords, may be stored in a codebook that is replicated in the sending and receiving bus for each core contained on the chip. In addition to the codebook, lightweight code housing reconstruction and deconstruction algorithms may be embedded in the firmware area of each processing core contained on the multi-core chip 3110. A first processing core may receive source data and encode it into codeword(s) as it is received 3115 using the deconstruction algorithm stored in the firmware of the first core. Then, the first core may transmit the codeword(s) to a second processing core contained on the same multi-core processing chip 3120. The second processing core may receive and decode the codeword(s) 3125 from the first processing core using the reconstruction algorithm stored in the firmware of the second core. Once the codewords have been decoded, the original data is instantaneously rebuilt 3130 by the second processing core. The rebuilt original data may then be sent as output to a given location.

### Hardware Architecture

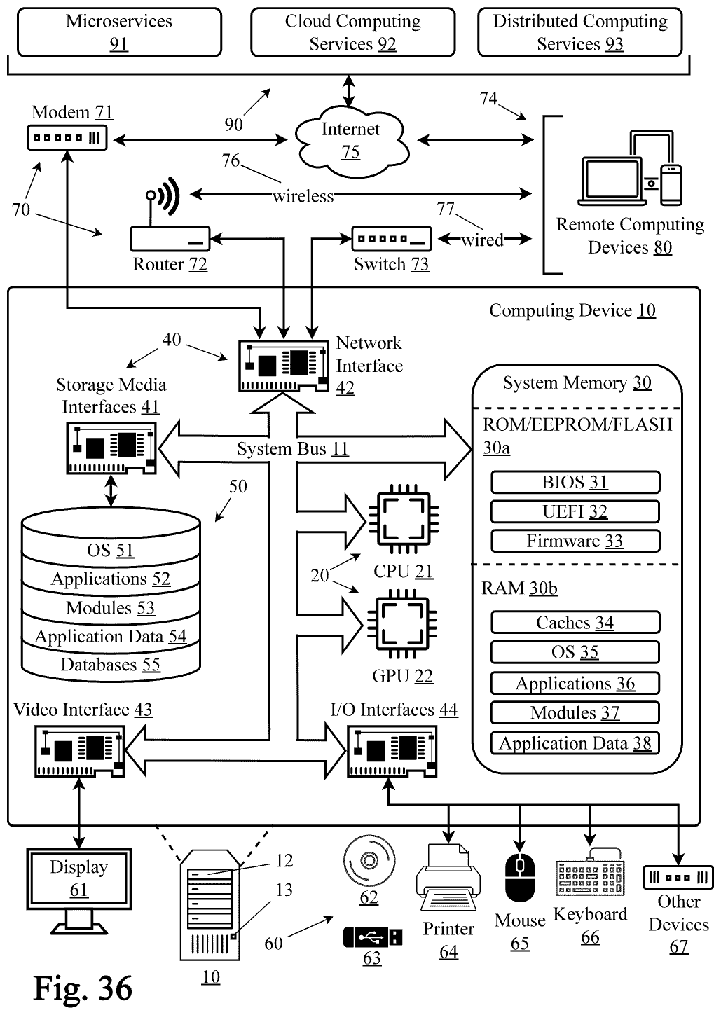

FIG. 36 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCle bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for optimizing intrachip communication using machine learning, comprising:
a computing device comprising at least a memory and a processor;
a plurality of programming instructions stored in the memory and operable on the processor, wherein the plurality of programming instructions, when operating on the processor, cause the computing device to:
collect data on codebook usage during intrachip communication;
extract features from the collected data;
analyze the extracted features using a machine learning model to recommend codebook updates;
implement the recommended updates to the codebook;
monitor performance metrics to evaluate the effectiveness of the updates; and
adjust the codebook refinement process based on the monitored performance metrics.

2. The system of claim 1, wherein the data collection is performed continuously during intrachip communication.

3. The system of claim 1, wherein the features extracted from the collected data include frequency of codeword usage, patterns of unmatched sourceblocks, and temporal patterns of data transmission.

4. The system of claim 1, wherein the machine learning model is designed for efficient execution within the constraints of on-chip resources.

5. The system of claim 1, wherein the implementation of recommended updates to the codebook occurs in real-time, thereby adapting the codebook to evolving data patterns.

6. The system of claim 1, wherein the monitored performance metrics include compression ratio, encoding/decoding speed, and frequency of codebook misses.

7. The system of claim 1, wherein the plurality of programming instructions further cause the computing device to maintain system stability by implementing gradual updates to the codebook, wherein the rate of change is dynamically adjusted based on the monitored performance metrics.

8. The system of claim 1, wherein the plurality of programming instructions further cause the computing device to provide a fallback mechanism to a pre-trained, conservative codebook during initial operation or if performance falls below a threshold.

9. The system of claim 1, wherein the plurality of programming instructions further cause the computing device to implement a secure update mechanism using cryptographic signatures to prevent unauthorized codebook modifications.

10. The system of claim 1, wherein the plurality of programming instructions further cause the computing device to optimize power consumption by adjusting the codebook refinement process based on the current power state of the chip.

11. The system of claim 1, wherein the machine learning model is incrementally trained using the collected data, allowing for ongoing adaptation to changing data patterns without the need for offline retraining.

12. The system of claim 1, wherein the plurality of programming instructions further cause the computing device to implement a multi-level codebook system, wherein different codebooks are optimized for different types of data or different parts of the chip, and are selected dynamically based on the current communication context.

13. The system of claim 1, wherein the plurality of programming instructions further cause the computing device to use synthetic data generation techniques to augment training data during initial system operation.

14. The system of claim 1, wherein the plurality of programming instructions further cause the computing device to implement an anomaly detection mechanism to identify potential security threats based on unusual patterns in codebook usage or update requests.

15. A method for optimizing intrachip communication using machine learning, comprising the steps of:
collecting data on codebook usage during intrachip communication;
extracting features from the collected data;
analyzing the extracted features using a machine learning model to recommend codebook updates;
implementing the recommended updates to the codebook;
monitoring performance metrics to evaluate the effectiveness of the updates; and
adjusting the codebook refinement process based on the monitored performance metrics.

16. The method of claim 15, wherein the data collection is performed continuously during intrachip communication.

17. The method of claim 15, wherein the features extracted from the collected data include frequency of codeword usage, patterns of unmatched sourceblocks, and temporal patterns of data transmission.

18. The method of claim 15, wherein the machine learning model is designed for efficient execution within the constraints of on-chip resources.

19. The method of claim 15, wherein the implementation of recommended updates to the codebook occurs in real-time, thereby adapting the codebook to evolving data patterns.

20. The method of claim 15, wherein the monitored performance metrics include compression ratio, encoding/decoding speed, and frequency of codebook misses.

21. The method of claim 15, further comprising the step of maintaining system stability by implementing gradual updates to the codebook, wherein the rate of change is dynamically adjusted based on the monitored performance metrics.

22. The method of claim 15, further comprising the step of providing a fallback mechanism to a pre-trained, conservative codebook during initial operation or if performance falls below a threshold.

23. The method of claim 15, further comprising the step of implementing a secure update mechanism using cryptographic signatures to prevent unauthorized codebook modifications.

24. The method of claim 15, further comprising the step of optimizing power consumption by adjusting the codebook refinement process based on the current power state of the chip.

25. The method of claim 15, wherein the machine learning model is incrementally trained using the collected data, allowing for ongoing adaptation to changing data patterns without the need for offline retraining.

26. The method of claim 15, further comprising the step of implementing a multi-level codebook system, wherein different codebooks are optimized for different types of data or different parts of the chip, and are selected dynamically based on the current communication context.

27. The method of claim 15, further comprising the step of using synthetic data generation techniques to augment training data during initial system operation.

28. The method of claim 15, further comprising the step of implementing an anomaly detection mechanism to identify potential security threats based on unusual patterns in codebook usage or update requests.
